(19) United States
(12) Patent Application Publication
(10) Pub. No.: US 2024/0089019 A1
(43) Pub. Date: Mar. 14, 2024

(54) ENHANCED CROSS LINK INTERFERENCE MEASUREMENT AND MANAGEMENT

(71) Applicant: QUALCOMM Incorporated, San Diego, CA (US)

(72) Inventors: Huilin XU, Temecula, CA (US); Yuwei REN, Beijing (CN); Qunfeng HE, San Diego, CA (US)

(21) Appl. No.: 18/263,687

(22) PCT Filed: Mar. 31, 2021
(86) PCT No.: PCT/CN2021/084289

§ 371 Date: Jul. 31, 2023

(51) Int. Cl. H04B 17/345; H04B 17/318; H04W 24/10

(52) U.S. Cl. CPC H04B 17/345; H04B 17/328; H04W 24/10

(57) ABSTRACT

A user equipment (UE) may receive a resource configuration indicating cross link interference (CLI) measurement resources, measure receive strength signal indicator (RSSI) values on the CLI measurement resources, respectively, and determine whether one or more RSSI values of the multiple of RSSI values exceed an RSSI threshold, the one or more RSSI values being respectively associated with one or more CLI measurement resources of the CLI measurement resources. The UE may measure at least one reference signal received power (RSRP) value respectively on at least one CLI measurement resource of the one or more CLI measurement resources in response to determining that the one or more RSSI values exceed the RSSI threshold. The UE may transmit an RSRP measurement report, the RSRP measurement report including the at least one RSRP value and at least one resource index respectively indicating the at least one CLI measurement resource.

### TECHNICAL FIELD

The technology discussed below relates generally to wireless communication systems, and more particularly, to cross link interference measurement at a user equipment.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources.

In wireless communication systems, such as those specified under standards for 5G New Radio (NR), a base station may communicate with a user equipment (UE) (e.g., a smartphone). In some instances, multiple UEs may communicate with the base station, and may communicate with the base station simultaneously. A communication from one UE to one base station may cause interference in a communication by another nearby UE with the same base station or a different base station. This interference may degrade performance and reliability of the communication by the UEs. As the demand for mobile broadband access continues to increase, the possibilities of interference and congested networks grows with more UEs accessing the long-range wireless communication networks and more short-range wireless systems being deployed in communities.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

A cross link interference (CLI) may occur when a communication by one UE (e.g., aggressor UE) interferes with a communication by another UE (e.g., victim UE). The CLI at the victim UE may be measured by taking receive strength signal indicator (RSSI) measurements and/or reference signal received power (RSRP) measurements. Although the RSRP measurements are more accurate that the RSSI measurements, the RSRP measurements are more complex and time-consuming, thus causing more overhead. Hence, an efficient approach to measure the CLI using the RSSI measurements and the RSRP measurements is provided.

In one example, a method of measuring a CLI by a user equipment (UE) is disclosed. The method includes receiving, from a base station, a resource configuration indicating a plurality of CLI measurement resources, measuring a plurality of receive strength signal indicator (RSSI) values on the plurality of CLI measurement resources, respectively, determining whether one or more RSSI values of the plurality of RSSI values exceed an RSSI threshold, the one or more RSSI values being respectively associated with one or more CLI measurement resources of the plurality of CLI measurement resources, measuring at least one reference signal received power (RSRP) value respectively on at least one CLI measurement resource of the one or more CLI measurement resources in response to determining that the one or more RSSI values exceed the RSSI threshold, and transmitting, to the base station, an RSRP measurement report, the RSRP measurement report including the at least one RSRP value respectively associated with the at least one CLI measurement resource and further including at least one resource index respectively indicating the at least one CLI measurement resource.

In another example, a UE for measuring a CLI is disclosed. The UE includes at least one processor, a transceiver communicatively coupled to the at least one processor, and a memory communicatively coupled to the at least one processor. The at least one processor may be configured to receive, from a base station, a resource configuration indicating a plurality of CLI measurement resources, measure a plurality of RSSI values on the plurality of CLI measurement resources, respectively, determine whether one or more RSSI values of the plurality of RSSI values exceed an RSSI threshold, the one or more RSSI values being respectively associated with one or more CLI measurement resources of the plurality of CLI measurement resources, measure at least one RSRP value respectively on at least one CLI measurement resource of the one or more CLI measurement resources in response to determining that the one or more RSSI values exceed the RSSI threshold, and transmit, to the base station, an RSRP measurement report, the RSRP measurement report including the at least one RSRP value respectively associated with the at least one CLI measurement resource and further including at least one resource index respectively indicating the at least one CLI measurement resource.

In another example, a non-transitory processor-readable storage medium having instructions for a UE thereon may be disclosed. The instructions, when executed by a processing circuit, cause the processing circuit to receive, from a base station, a resource configuration indicating a plurality of CLI measurement resources, measure a plurality of RSSI values on the plurality of CLI measurement resources, respectively, determine whether one or more RSSI values of the plurality of RSSI values exceed an RSSI threshold, the one or more RSSI values being respectively associated with one or more CLI measurement resources of the plurality of CLI measurement resources, measure at least one RSRP value respectively on at least one CLI measurement resource of the one or more CLI measurement resources in response to determining that the one or more RSSI values exceed the RSSI threshold, and transmit, to the base station, an RSRP measurement report, the RSRP measurement report including the at least one RSRP value respectively associated with the at least one CLI measurement resource and further including at least one resource index respectively indicating the at least one CLI measurement resource.

In a further example, a UE for measuring a CLI may be disclosed. The UE includes means for receiving, from a base station, a resource configuration indicating a plurality of CLI measurement resources; measuring a plurality of RSSI values on the plurality of CLI measurement resources, respectively; means for determining whether one or more RSSI values of the plurality of RSSI values exceed an RSSI threshold, the one or more RSSI values being respectively associated with one or more CLI measurement resources of the plurality of CLI measurement resources; means for measuring at least one RSRP value respectively on at least one CLI measurement resource of the one or more CLI measurement resources in response to determining that the one or more RSSI values exceed the RSSI threshold; and means for transmitting, to the base station, an RSRP measurement report, the RSRP measurement report including the at least one RSRP value respectively associated with the at least one CLI measurement resource and further including at least one resource index respectively indicating the at least one CLI measurement resource.

In one example, a method of identifying at least one aggressor UE causing a CLI by a base station is disclosed. The method includes transmitting, to a UE, a resource configuration indicating a plurality of CLI measurement resources, receiving, from the UE, a RSRP measurement report, the RSRP measurement report including at least one RSRP value respectively associated with at least one CLI measurement resource of the plurality of CLI measurement resources and further including at least one resource index respectively indicating the at least one CLI measurement resource, wherein the at least one RSRP value is measured on the at least one CLI measurement resource of one or more CLI measurement resources of the plurality of CLI measurement resources, and wherein the one or more CLI measurement resources are associated with one or more RSSI values measured on the one or more CLI measurement resources and exceeding the RSSI threshold, and determining that at least one second UE of one or more second UEs that is associated with the at least one CLI measurement resource is an aggressor UE based on the RSRP measurement report.

In another example, a base station for identifying at least one aggressor UE causing a CLI is disclosed. The base station includes at least one processor, a transceiver communicatively coupled to the at least one processor, and a memory communicatively coupled to the at least one processor. The at least one processor may be configured to transmit, to a UE, a resource configuration indicating a plurality of CLI measurement resources, receive, from the UE, a RSRP measurement report, the RSRP measurement report including at least one RSRP value respectively associated with at least one CLI measurement resource of the plurality of CLI measurement resources and further including at least one resource index respectively indicating the at least one CLI measurement resource, wherein the at least one RSRP value is measured on the at least one CLI measurement resource of one or more CLI measurement resources of the plurality of CLI measurement resources, and wherein the one or more CLI measurement resources are associated with one or more RSSI values measured on the one or more CLI measurement resources and exceeding the RSSI threshold, and determine that at least one second UE of one or more second UEs that is associated with the at least one CLI measurement resource is an aggressor UE based on the RSRP measurement report.

In another example, a non-transitory processor-readable storage medium having instructions for a base station thereon may be disclosed. The instructions, when executed by a processing circuit, cause the processing circuit to transmit, to a UE, a resource configuration indicating a plurality of CLI measurement resources, receive, from the UE, a RSRP measurement report, the RSRP measurement report including at least one RSRP value respectively associated with at least one CLI measurement resource of the plurality of CLI measurement resources and further including at least one resource index respectively indicating the at least one CLI measurement resource, wherein the at least one RSRP value is measured on the at least one CLI measurement resource of one or more CLI measurement resources of the plurality of CLI measurement resources, and wherein the one or more CLI measurement resources are associated with one or more RSSI values measured on the one or more CLI measurement resources and exceeding the RSSI threshold, and determine that at least one second UE of one or more second UEs that is associated with the at least one CLI measurement resource is an aggressor UE based on the RSRP measurement report.

In a further example, a base station for identifying at least one aggressor UE causing a CLI may be disclosed. The base station includes means for transmitting, to a UE, a resource configuration indicating a plurality of CLI measurement resources, means for receiving, from the UE, a RSRP measurement report, the RSRP measurement report including at least one RSRP value respectively associated with at least one CLI measurement resource of the plurality of CLI measurement resources and further including at least one resource index respectively indicating the at least one CLI measurement resource, wherein the at least one RSRP value is measured on the at least one CLI measurement resource of one or more CLI measurement resources of the plurality of CLI measurement resources, and wherein the one or more CLI measurement resources are associated with one or more RSSI values measured on the one or more CLI measurement resources and exceeding the RSSI threshold, and means for determining that at least one second UE of one or more second UEs that is associated with the at least one CLI measurement resource is an aggressor UE based on the RSRP measurement report.

These and other aspects of the disclosure will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a block diagram illustrating a wireless communication system supporting multiple-input multiple-output (MIMO) communication.

FIG. 4 is a schematic illustration of an organization of wireless resources in an air interface utilizing orthogonal frequency divisional multiplexing (OFDM) according to some embodiments.

FIG. 5 is an example diagram illustrating a cross link interference between two UEs, according to some aspects.

FIG. 6A is an example diagram illustrating a cross link interference (CLI) occurring between UEs on different cells, according to some aspects.

FIG. 6B is an example diagram illustrating a CLI occurring between UEs in the same cell, according to some aspects.

FIG. 7 is an example flow diagram illustrating a CLI measurement procedure by a victim UE, according to some aspects.

FIG. 8 is an example diagram illustrating a victim UE measuring receive strength signal indicator (RSSI) values and reference signal received power (RSRP) values on CLI measurement resources configured by a base station, according to some aspects.

FIGS. 9A and 9B are example diagrams illustrating the use of the CLI measurement resources for the RSSI measurement and the RSRP measurement, according to some aspects.

FIGS. 10A and 10B are example diagrams illustrating the use of the CLI measurement resources for the RSSI measurement and the RSRP measurement, according to some aspects.

FIG. 11 is an example flow diagram illustrating a CLI measurement procedure based on RSSI and RSRP measurements, according to some aspects.

FIG. 12 is a block diagram conceptually illustrating an example of a hardware implementation for a UE, according to some aspects.

FIG. 13 is a flow chart illustrating an exemplary process for measuring a CLI, according to some aspects.

FIGS. 14A and 14B are flow charts illustrating an exemplary process for measuring a CLI, according to some aspects.

FIG. 15 is a block diagram conceptually illustrating an example of a hardware implementation for a base station, according to some aspects.

FIG. 16 is a flow chart illustrating an exemplary process for identifying at least one aggressor UE causing a CLI, according to some aspects.

FIGS. 17A and 17B are flow charts illustrating an exemplary process for identifying at least one aggressor UE causing a CLI, according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

When a transmission by one user equipment (UE) (e.g., aggressor UE) interferes with a reception by another UE (e.g., victim UE), a the victim UE may suffer from a cross link interference (CLI). The victim UE may measure the CLI on particular resources configured by a base station. For example, the victim UE may measure receive strength signal indicator (RSSI) values on RSSI resources and/or may measure reference signal received power (RSRP) values on RSRP resources, and report the RSSI values and/or the RSRP values to the base station, such that the base station may manage the CLI and schedule the UEs. Although the RSRP measurements are more accurate that the RSSI measurements, the RSRP measurements are more complex and time-consuming, thus causing more overhead.

According to some aspects of the disclosure, the UE may be configured with CLI measurement resources that may be used for the RSSI measurement and the RSRP measurement. The UE may first measure RSSI values on the CLI measurement resources. For CLI measurement resources having RSSI values exceeding a RSSI threshold, the UE may measure RSRP values on these CLI measurement resources and report the RSRP values to the base station. Because the UE focuses on certain CLI measurement resources having high RSSI values (e.g., exceeding the RSSI threshold) for the RSRP measurements, the overhead for the RSRP measurement is reduced while taking advantage of the RSRP measurements.

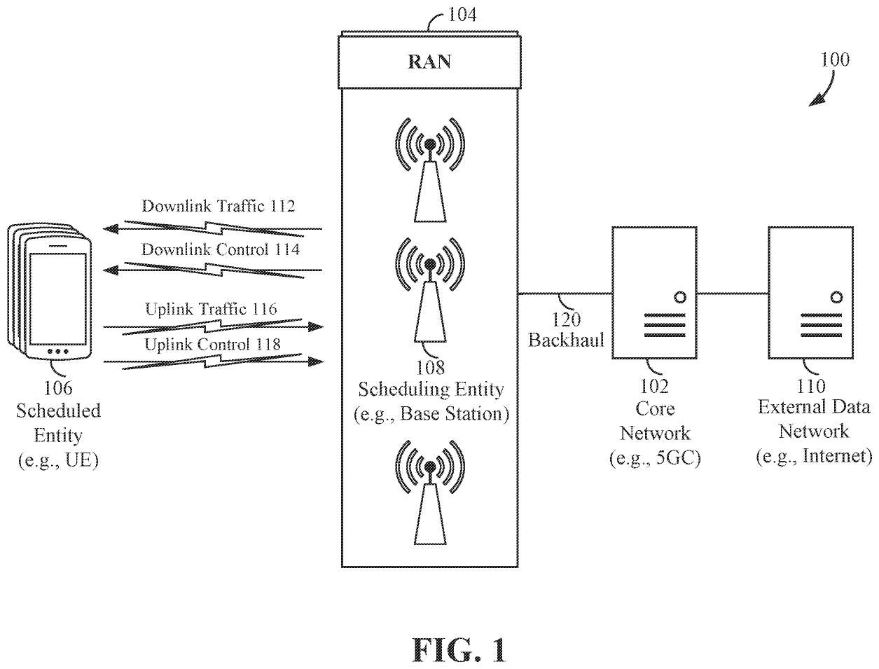

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP) or some other suitable terminology. In some examples, a base station may include two or more TRPs that may be collocated or non-collocated. Each TRP may communicate on the same or different carrier frequency within the same or different frequency band.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors. etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; vehicles, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication. UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

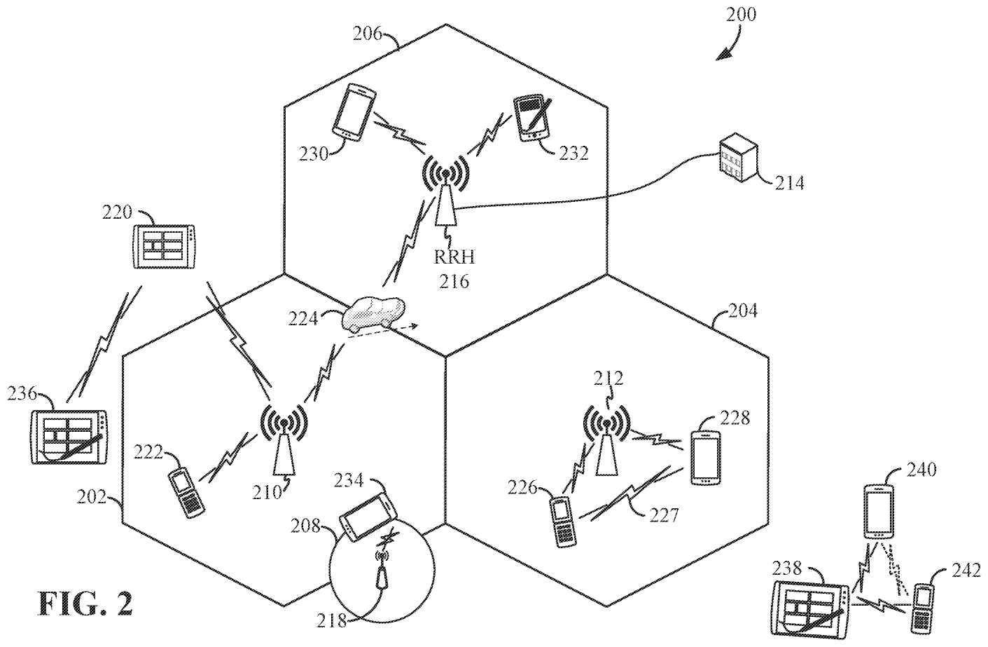

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 126 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a mobile device 220, which may be configured to function as a base station. That is, in some examples, a cell may not necessarily be stationary, and the geographic area of the cell may move according to the location of a mobile base station such as the mobile device 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., mobile device 220) may be configured to function as a UE. For example, the mobile device 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

In the radio access network 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

In various aspects of the disclosure, a radio access network 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the radio access network 200. Each of the cells may measure a strength of the pilot signal, and the radio access network (e.g., one or more of the base stations 210 and 214/216 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

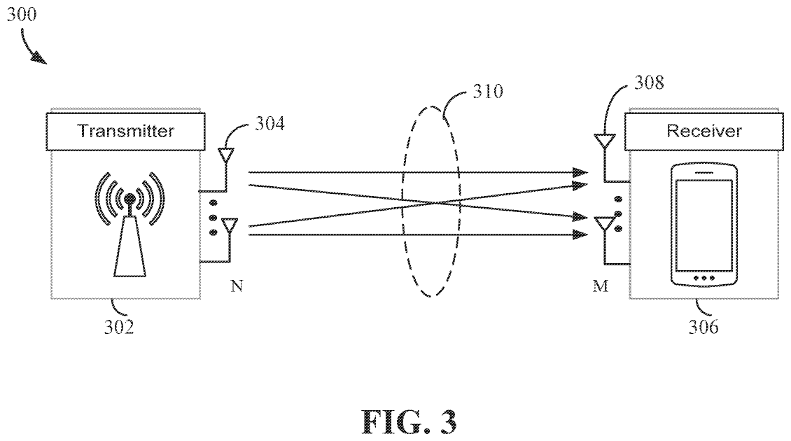

In some aspects of the disclosure, the scheduling entity and/or scheduled entity may be configured for beamforming and/or multiple-input multiple-output (MIMO) technology. FIG. 3 illustrates an example of a wireless communication system 300 supporting MIMO. In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system 300 is limited by the number of transmit or receive antennas 304 or 308, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on a Sounding Reference Signal (SRS) transmitted from the UE or other pilot signal). Based on the assigned rank, the base station may then transmit the CSI-RS with separate C-RS sequences for each layer to provide for multi-layer channel estimation. From the CSI-RS, the UE may measure the channel quality across layers and resource blocks and feed back the CQI and RI values to the base station for use in updating the rank and assigning REs for future downlink transmissions.

In the simplest case, as shown in FIG. 3, a rank-2 spatial multiplexing transmission on a 2×2 MIMO antenna configuration will transmit one data stream from each transmit antenna 304. Each data stream reaches each receive antenna 308 along a different signal path 310. The receiver 306 may then reconstruct the data streams using the received signals from each receive antenna 308.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

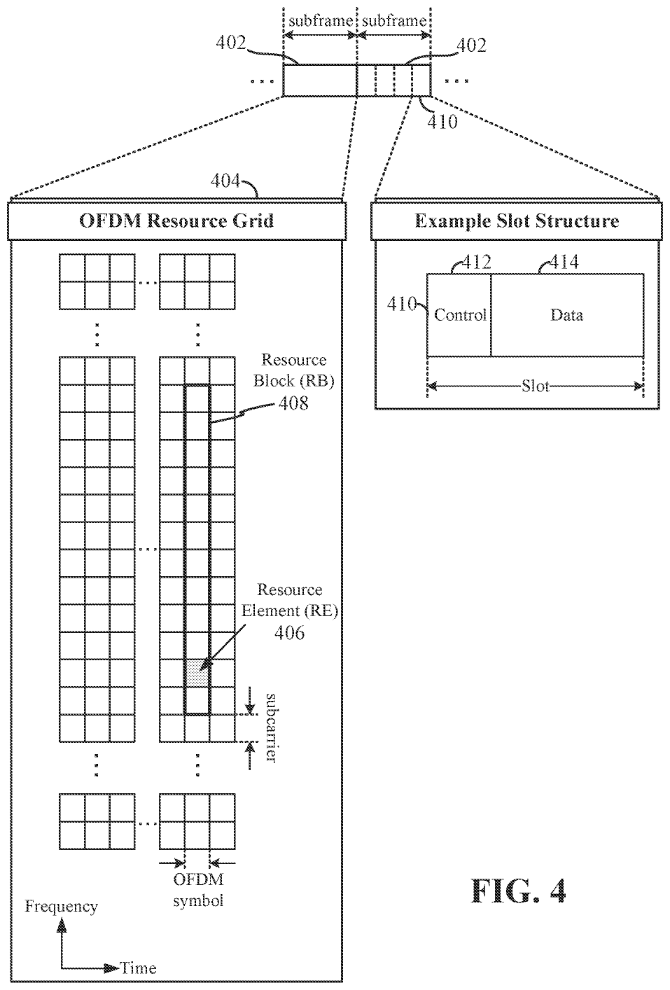

Various aspects of the present disclosure will be described with reference to an OFDM waveform, schematically illustrated in FIG. 4. It should be understood by those of ordinary skill in the art that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

Within the present disclosure, a frame refers to a duration of 10 ms for wireless transmissions, with each frame consisting of 10 subframes of 1 ms each. On a given carrier, there may be one set of frames in the UL, and another set of frames in the DL. Referring now to FIG. 4, an expanded view of an exemplary DL subframe 402 is illustrated, showing an OFDM resource grid 404. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 404 may be used to schematically represent time-frequency resources for a given antenna port. That is, in a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A UE generally utilizes only a subset of the resource grid 404. An RB may be the smallest unit of resources that can be allocated to a UE. Thus, the more RBs scheduled for a UE, and the higher the modulation scheme chosen for the air interface, the higher the data rate for the UE.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each subframe 402 (e.g., a 1 ms subframe) may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., 1, 2, 4, or 7 OFDM symbols). These mini-slots may in some cases be transmitted occupying resources scheduled for ongoing slot transmissions for the same or for different UEs.

An expanded view of one of the slots 410 illustrates the slot 410 including a control region 412 and a data region 414. In general, the control region 412 may carry control channels (e.g., PDCCH), and the data region 414 may carry data channels (e.g., PDSCH or PUSCH). Of course, a slot may contain all DL, all UL, or at least one DL portion and at least one UL portion. The simple structure illustrated in FIG. 4 is merely exemplary in nature, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 140 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. Examples of system information transmitted in the MIB may include, but are not limited to, a subcarrier spacing, system frame number, a configuration of a PDCCH control resource set (CORESET) (e.g., PDCCH CORESET0), and a search space for SIB1. Examples of additional system information transmitted in the SIB1 may include, but are not limited to, a random access search space, downlink configuration information, and uplink configuration information. The MIB and SIB1 together provide the minimum system information (SI) for initial access.

In an UL transmission, the scheduled entity (e.g., UE) may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs.

In an example of sidelink communication over a sidelink carrier via a PC5 interface, the control region 412 of the slot 410 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device.

The channels or carriers described above and illustrated in FIGS. 1 and 4 are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

When a communication by one UE (e.g., aggressor UE) interferes with a communication by another UE (e.g., victim UE), this interference may be referred to as a cross link interference (CLI). An aggressor UE is a UE that causes an interference and a victim UE is a UE that experiences the interference by the aggressor UE. For example, the CLI measurements by a victim UE may be based on a signal and a noise from a neighboring aggressor UE. While the victim UE is receiving a signal (e.g., SRS signal) on a particular resource (e.g., symbol), the victim UE may measure the CLI on this particular resource. In an example, if a first UE is transmitting a signal while a second UE is receiving, the signal being transmitted by the first UE may interfere with the signal being received by the second UE, and thus the first UE may be the aggressor UE and the second UE may be the victim UE. In this example, the signal being transmitted may be stronger than the signal being received, so as to cause the interference on the signal received.

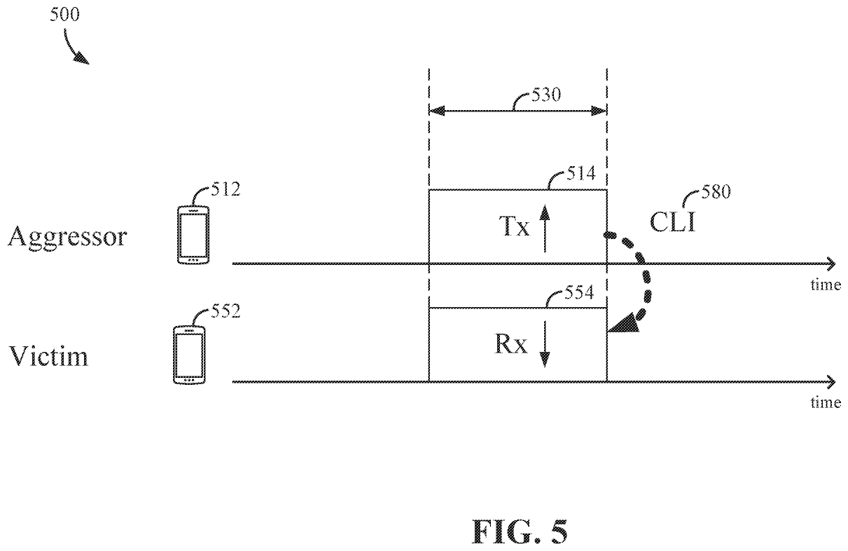

The CLI may occur when a base station configures respective TDD UL/DL slot formats to UEs that are close to each other. For example, while a first UE is transmitting a signal, a second UE may receive this transmission by the first UE as a CLI in its DL symbol if the first UE's UL symbol used for the transmission by the first UE collides (e.g., overlaps) with at least one DL symbol used by the second UE. FIG. 5 is an example diagram 500 illustrating a cross link interference between two UEs, according to some aspects. In FIG. 5, an aggressor UE 512 may transmit a first signal 514 during a symbol 530, while a victim UE 552 may receive a second signal 554 during the same symbol 530. As such, the first signal 514 being transmitted by the aggressor UE 512 may be received by the victim UE 552 during the symbol 530, as a CLI 580. The CLI 580 may interfere with the victim UE 552 receiving the second signal 554, and thus may cause noise or unreliability in the reception of the second signal 554 by the victim UE 552.

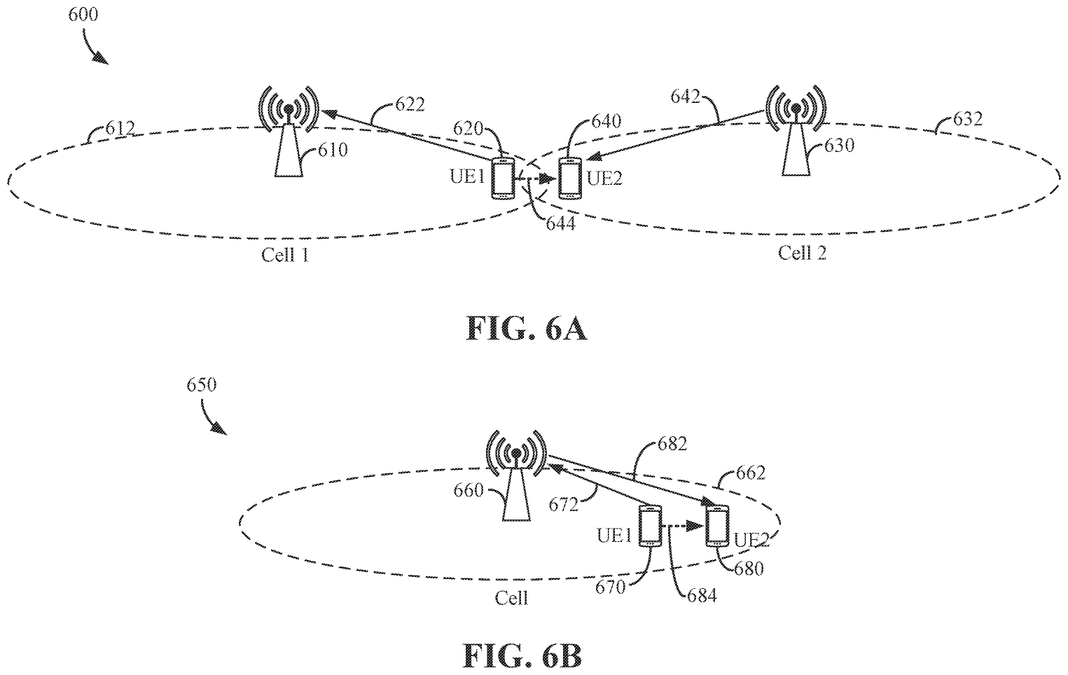

The CLI can occur between UEs on the same cell or between UEs on different cells. FIG. 6A is an example diagram 600 illustrating a CLI occurring between UEs in different cells, according to some aspects. In FIG. 6A, a first base station 610 operates a first cell 612, where a first UE 620 is camped. Further, in FIG. 6A, a second base station 630 operates a second cell 632, where a second UE 640 is camped. The first UE 620 transmits a signal 622 to the first base station 610 while the second UE 640 receives a signal 642 from the second base station 630 (e.g. during a same symbol). The first UE 620 and the second UE 640 are nearby each other, although the first UE 620 and the second UE 640 are in different cells. Hence, the signal 622 transmitted by the first UE 620 (e.g., aggressor UE) may be received by the second UE 640 (e.g., victim UE), thereby causing a CLI 644. FIG. 6B is an example diagram 650 illustrating a CLI occurring between UEs in the same cell, according to some aspects. In FIG. 6B, a base station 660 operates a cell 662, where a first UE 670 and a second UE 680 are camped. The first UE 670 transmits a signal 672 to the base station 660 while the second UE 680 receives a signal 682 from the base station 660 (e.g. during a same symbol). Hence, the signal 672 transmitted by the first UE 670 (e.g., aggressor UE) may be received by the second UE 680 (e.g., victim UE), thereby causing a CLI 684.

A CLI measurement procedure has been developed to allow a victim UE to measure a CLI from an aggressor UE. In an aspect, during the CLI measurement procedure, the aggressor UE may not be involved with signaling associated with the CLI measurement procedure and may not know that the signal transmitted by the aggressor UE that is causing the CLI is measured by the victim UE. During the CLI measurement procedure, a base station may configure a victim UE with one or more resources, such that the victim UE may measure a CLI on these resources. The resources for the CLI measurements may include receive strength signal indicator (RSSI) resources for measuring RSSI values and/or reference signal received power (RSRP) resources for measuring RSRP values. Hence, the UE may measure the CLI by measuring one or more RSSI values on the RSSI resources and/or by measuring one or more RSRP values on the RSRP resources. In an example, the resources for the CLI measurement may be SRS resources. For example, the victim UE may measure the RSSI values on SRS signal transmissions on RSSI resources that are SRS resources and/or may measure RSRP values on SRS signal transmissions on RSRP resources that are SRS resources. The CLI measurement by the victim UE may take place periodically or aperiodically. After performing the CLI measurement, the CLI measurements such as the RSSI values and/or the RSRP values may be transmitted to the base station in a CLI measurement report.

In an example, when the base station determines that two UEs are geographically close to each other and one of the two UEs is losing throughput, the base station may identify the UE losing the throughput as the victim UE and the other UE as the aggressor UE. When the base station identifies the victim UE, the CLI measurement procedure may begin by the base station transmitting a resource configuration of the resources for the CLI measurement to the victim UE, as discussed above. For example, the resource configuration may be transmitted in a radio resource control (RRC) message.

Based on the CLI measurement, the base station may manage scheduling of the aggressor UE and the victim UE to balance the throughput of the aggressor UE and the victim UE. If the aggressor UE and the victim UE are in two different cells, two base stations operating the two different cells may communicate with each other to schedule the aggressor UE and the victim UE to balance the throughput of the aggressor UE and the victim UE, based on the CLI measurement report. For example, the base station that has received the CLI measurement report from the victim UE may forward the CLI measurement report to the base station connected to the aggressor UE, and these two base stations may subsequently communicate to schedule the aggressor UE and the victim UE based on the CLI measurement report. In an example, the CLI measurement procedure described above may be transparent to the aggressor UE.

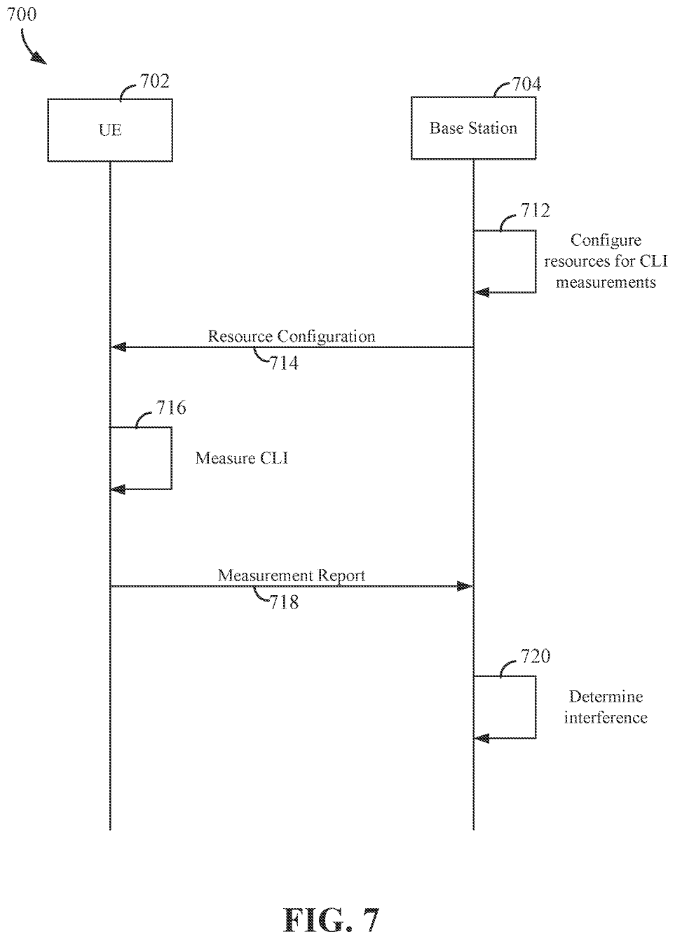

FIG. 7 is an example flow diagram 700 illustrating a CLI measurement procedure by a victim UE, according to some aspects. The CLI measurement procedure in FIG. 7 may be performed by a UE 702 and a base station 704. At 712, the base station 704 may configure resources for CLI measurements. The resources for CLI measurements may be RSSI resources for RSSI measurements and/or RSRP resources for RSRP measurements. At 714, the base station 704 may transmit a resource configuration indicating the resources for the CLI measurement to the UE 702. At 716, the UE performs CLI measurements on the resources indicated by the resource configuration. The CLI measurements may be RSSI measurements on the RSSI resources and/or RSRP measurements on the RSRP resources. At 718, the UE 702 may transmit a measurement report including the CLI measurements. At 720, the base station 704 may determine the CLI interference based on the CLI measurements, and may schedule the UE 702 (e.g., and an aggressor UE) based on the CLI measurements.

As discussed above, to measure the CLI, the victim UE may perform RSSI measurements on RSSI resources and/or the RSRP measurements on RSRP resources. The RSSI measurements as the CLI measurements may have less requirements than the RSRP measurements as the CLI measurements. For example, the RSSI measurement may be a total power including signal and noise interference, which does not take much processing power to compute. Further, the RSSI measurement may be measured in time domain, e.g., by averaging of power, and thus there is no complex baseband computation. On the other hand, the RSRP measurement measures a signal contribution excluding a noise, and such a computation requires a conversion from time domain samples to frequency domain samples as well as frequency domain operations, which is a demanding complex operation. However, the RSRP measurements as the CLI measurements may be more accurate than the RSSI measurements as the CLI measurements. This may be because the RSRP measurement relies on coherent processing of the resources and excludes effects from a noise.

The CLI measurements as described above may be complex and inefficient. A base station may not know which aggressor UE causes the CLI to a victim UE. For example, the base station may not know whether two UEs with TDD configurations that may cause the CLI are close to each other in their positions. This issue may be more serious for the frequency range corresponding to FR1 where it is difficult for the base station to determine a position of a victim UE due to the wide beam nature of the FR1 frequency range. Hence, the base station may configure respective CLI measurement resources for all potential victim UEs to measure CLIs for all potential aggressor UEs within the same cell operated by the base station, which may consume a large amount of resources. Further, to identify a specific aggressor UE, the base station may configure RSRP resources for RSRP measurements, and the victim UE may measure RSRP values on the RSRP resources, since the RSRP measurements provide more accurate CLI measurements than RSSI measurements. However, measuring the RSRP values on the RSRP resources is a very demanding operation and thus may be very time-consuming, as described above. Hence, improvements in the process associated with CLI measurements may be made, as discussed in more detail below.

According to some aspects of the disclosure, a UE may utilize a multi-stage CLI measurement process, where the UE may measure RSSI values on CLI measurement resources, and if one or more RSSI values respectively associated with one or more CLI measurement resources exceed an RSSI threshold, the UE may measure at least one RSRP value on at least one of the one or more CLI measurement resources where the one or more RSSI values exceed the RSSI threshold. The CLI measurement resources may be configured by a base station, where the base station may transmit a resource configuration indicating the CLI measurement resources (e.g., via an RRC message). The UE may transmit a measurement report including the RSSI values and/or the at least one RSRP value to the base station. Based on the measurement report, the base station may identify an aggressor UE and may manage scheduling of UEs to reduce the CLI.

Hence, for example, for a first stage, the UE may measure RSSI values on many CLI measurement resources because RSSI measurements are not as complex or demanding as RSRP measurements. Then, for a second stage, the UE may focus on one or more CLI measurement resources associated with respective one or more RSSI values exceeding the RSSI threshold, for the RSRP measurements. Hence, a number of the one or more CLI measurement resources for measuring the RSRP measurements may be smaller than a number of CLI measurement resources for measuring the RSSI measurements. For example, an RSSI exceeding the RSSI threshold on a particular CLI measurement resource may indicate that an aggressor UE is likely to be transmitting on this particular CLI measurement resource, and thus an RSRP measurement may be made on this particular CLI measurement resource to obtain an RSRP value that is a more accurate signal measurement than the RSSI value. Hence, for example, RSSI measurements may be made on a large number of CLI measurement resources, and then RSRP measurements may be made on a smaller number of CLI measurement resources that are associated with RSSI values exceeding the RSSI threshold. Because the UE may not measure RSRP values on all of the available resources but may focus the RSRP measurements on resources associated with RSSI values exceeding the RSSI threshold, the UE may utilize the processing power and its battery power more efficiently, thereby reducing the overhead of the RSRP measurements while utilizing the accuracy of the RSRP measurements. In an aspect, the CLI measurement resources may be SRS resources different from the RSSI resources or the RSRP resources.

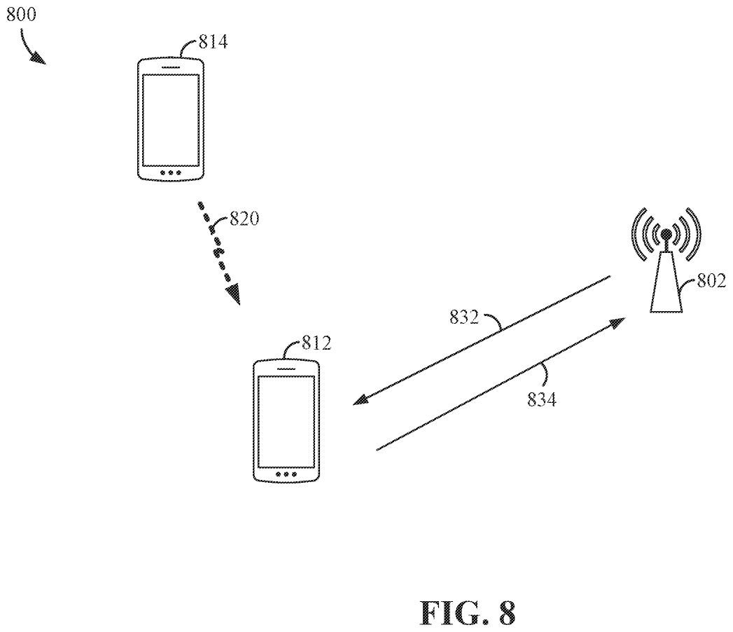

FIG. 8 is an example diagram 800 illustrating a victim UE measuring RSSI values and RSRP values on CLI measurement resources configured by a base station, according to some aspects. A base station 802 may transmit a resource configuration indicating CLI measurement resources to a UE 812. The UE 812 may be under the effect of a CLI 820 caused by an aggressor UE 814. For example, while the UE 812 may attempt to receive a first signal during a particular resource (e.g., symbol), the aggressor UE 814 may use the same particular resource to transmit a second signal (e.g., not intended for the UE 812), which may be received by the UE 812 and thus cause the CLI 820 at the UE 812 attempting to receive the second signal.

After receiving the resource configuration from the base station 802, the UE 812 may measure RSSI values respectively on the CLI measurement resources indicated by the resource configuration. Subsequently, the UE 812 may determine whether one or more RSSI values of the measured RSSI values exceed an RSSI threshold, where the one or more RSSI values are respectively associated with one or more CLI measurement resources of the CLI measurement resources. If one or more RSSI values of the measured RSSI values exceed the RSSI threshold, the UE 812 may measure at least one RSRP value respectively on at least one CLI measurement resource of the one or more CLI measurement resources, where the one or more CLI measurement resources are respectively associated with the one or more RSSI values exceeding the RSSI threshold. Then, at 834, the UE 812 may transmit an RSRP measurement report to the base station 802, where the RSRP measurement report may include the at least one RSRP value respectively associated with the at least one CLI measurement resource and may further including at least one resource index respectively indicating the at least one CLI measurement resource, to indicate the association at least one RSRP value and the at least one CLI measurement resource.

On the other hand, if none of the measured RSSI values exceed an RSSI threshold, the UE 812 may not make any RSRP measurements on any one of the CLI measurement resources. For example, this may be because none of the measured RSSI values exceeding the RSSI threshold may indicate that there is no CLI or that a CLI is not strong enough to be a concern for the UE 812.

In an aspect, the UE may receive the RSSI threshold from the base station. In another aspect, the UE may be preconfigured with the RSSI threshold. For example, the RSSI threshold may be determined based on offline simulations, and may be provided to the base station and/or the UE. Further, in an aspect, the base station may transmit an indication for a time to trigger the RSSI measurement to measure the RSSI values on the CLI measurement resources.

In an aspect, the CLI measurement resources may be configured by the base station such that the CLI measurement resources may cover an entire coverage area of a transmit beam of the base station corresponding to the UE. Accordingly, the UE may measure RSSI values on the CLI measurement resources for CLIs by UEs covering the coverage area near the transmit beam of the base station.

In an aspect, the CLI measurement resources may be different from the RSSI resources in that RSRP measurements may be made on the CLI resources. Further, for example, the CLI measurement resources may be different from the RSRP resources in that RSSI measurements may be made on the CLI resources.

In an aspect, the UE may transmit, to the base station, RSSI measurement resource capability information indicating a first number of CLI measurement resources on which the UE is capable of performing an RSSI measurement and an RSRP measurement. Because the CLI measurement resources may be for both the RSSI measurement and the RSRP measurement, the UE may measure the RSSI values on the CLI measurement resources and may measure RSRP values on the at least one CLI resource having an RSSI value exceeding the RSSI threshold. Based on the RSSI measurement resource capability information, the base station may determine the CLI measurement resources for the resource configuration for the UE such that a number of the CLI measurement resources may be less than or equal to the first number of CLI measurement resources.

In an aspect, the RSSI measurement resource capability information may further indicate a second number of resources on which the UE is capable of performing at least the RSSI measurement and/or a third number of RSSI resources on which the UE is capable of performing the RSSI measurement without the RSRP measurement. For example, the resources on which the UE is capable of performing at least the RSSI measurement may include at least some of the CLI measurement resources and at least some of the RSSI resources. Further, for example, RSSI measurements may be made on the RSSI resources, but RSRP measurements may not be made on the RSSI resources. In an aspect, the base station may determine the CLI measurement resources for the resource configuration such that if the first number of CLI measurement resources is less than or equal to the second number of resources, the number of the CLI measurement resources in the resource configuration may correspond to the first number of CLI measurement resources, and otherwise may correspond to the second number of measurement resources. For example, if the first number of CLI measurement resources is 30 and the second number of measurement resources is 50, then the number of the CLI measurement resources determined for the resource configuration may be 30. For example, if the first number of CLI measurement resources is 30 and the second number of measurement resources is 20, then the number of the CLI measurement resources determined for the resource configuration may be 20.

In an aspect, the second number of resources for the RSSI measurement on which the UE is capable of performing at least the RSSI measurement may be greater than or equal to the third number of RSSI resources on which the UE is capable of performing the RSSI measurement without the RSRP measurement, and the second number of resources for the RSSI measurement may be less than or equal to the sum of the third number of RSSI resources and the first number of CLI measurement resources. For example, assuming that A=the first number of CLI measurement resources on which the UE is capable of performing an RSSI measurement and an RSRP measurement, B=the second number of resources on which the UE is capable of performing at least the RSSI measurement, and C=the third number of RSSI resources on which the UE is capable of performing the RSSI measurement without the RSRP measurement, then C<=B<=A+C, in some aspects. For example, with the implementation of the CLI measurement resources, the second number of resources on which the UE is capable of performing at least the RSSI measurement may be greater than the third number of RSSI resources on which the UE is capable of performing the RSSI measurement without the RSRP measurement. In this example, a number of the CLI measurement resources determined for the resource configuration by the base station may be greater than the third number of RSSI resources. However, in another example, even with the implementation of the CLI measurement resources, the second number of resources on which the UE is capable of performing at least the RSSI measurement may be limited to the third number of RSSI resources, and thus a number of the CLI measurement resources determined for the resource configuration may be limited to the third number of RSSI resources.

In an aspect, the UE may transmit, to the base station, an RSRP measurement resource capability information indicating a fourth number of RSRP resources for an RSRP measurement on which the UE is capable of performing the RSRP measurement. In this aspect, the fourth number of RSRP resources for the RSRP measurement may be less than or equal to the first number of CLI measurement resources for the RSSI measurement. In an example, the base station may determine the CLI measurement resources for the resource configuration when the bae station determines that the fourth number of RSRP resources for the RSRP measurement is less than or equal to the first number of CLI measurement resources for the RSSI measurement. For example, if the CLI measurement resources are determined in the resource configuration, the fourth number of the RSRP resources may indicate a maximum number of the CLI measurement resources on which the RSRP measurements may be performed. On the other hand, if the UE is not configured with any CLI measurement resources, then the fourth number of RSRP resources may indicate a maximum number of RSRP resources on which the RSRP measurement may be performed.

In an aspect, the UE may select the at least one CLI measurement resource from the one or more CLI measurement resources whose RSSI values exceed the RSSI threshold based on the fourth number of RSRP resources for the RSRP measurement, where a number of the at least one CLI measurement resource is less than or equal to the fourth number of RSRP resources for the RSRP measurement. For example, a number of the CLI measurement resources on which the UE may perform the RSRP measurement is limited to the fourth number of RSRP resources. In an example, if the fourth number of the RSRP resources is 10 and the UE is configured with the CLI measurement resources, the UE may select up to 10 CLI measurement resources whose RSSI values exceeding the RSSI threshold to perform RSRP measurements.

In an aspect, each of the at least one CLI measurement resource selected from the one or more CLI measurement resources is associated with an RSSI value greater than an RSSI value associated with each of a rest of the one or more CLI measurement resources different from the at least one CLI measurement resource. For example, if the fourth number of the RSRP resources is 10 and there are 15 CLI measurement resources whose RSSI values exceed the RSSI threshold, then the UE may select 10 CLI measurement resources based on the fourth number of the RSRP resources, where the selected 10 CLI measurement resources have top 10 RSSI values among the 15 RSSI values associated with the 15 CLI measurement resources. Thus, in this example, the selected 10 CLI measurement resources may have RSSI values greater than RSSI values of the other 5 unselected CLI measurement resources.

In an aspect, the UE may transmit, to the base station, a multi-stage CLI capability indicator indicating that the UE is capable of a multi-stage CLI measurement including an RSSI measurement and an RSRP measurement. In this aspect, in response to receiving the multi-stage CLI capability indicator, the base station may determine the resource configuration indicating the CLI measurement resources and transmit the resource configuration to the UE. In an aspect, the UE may implicitly indicate the multi-stage CLI capability by transmitting the RSSI measurement resource capability information and the RSRP measurement resource capability information, where the RSRP measurement resource capability information indicates a smaller number of RSRP resources than a number of resources indicated by the RSSI measurement resource capability information. In response, the base station may determine the resource configuration indicating the CLI measurement resources and transmit the resource configuration to the UE.

In an aspect, the CLI measurement resources may be associated with one or more scrambling codes that are respectively associated with one or more aggressor UEs. In an aspect, the UE may receive from the base station association information indicating the association of the CLI measurement resources with the one or more scrambling codes. The UE may be able to determine which CLI measurement resource is associated with a particular aggressor UE, based on a particular scrambling code associated with the CLI measurement resource, because the particular scrambling code is associated with the particular aggressor UE. Hence, after receiving the association information, the UE may determine that at least one aggressor UE of the one or more aggressor UEs that is associated with the at least one CLI measurement resource on which the at least RSRP value is measured is an aggressor UE. In an aspect, the scrambling codes may be based on radio network temporary identifiers (RNTIs).

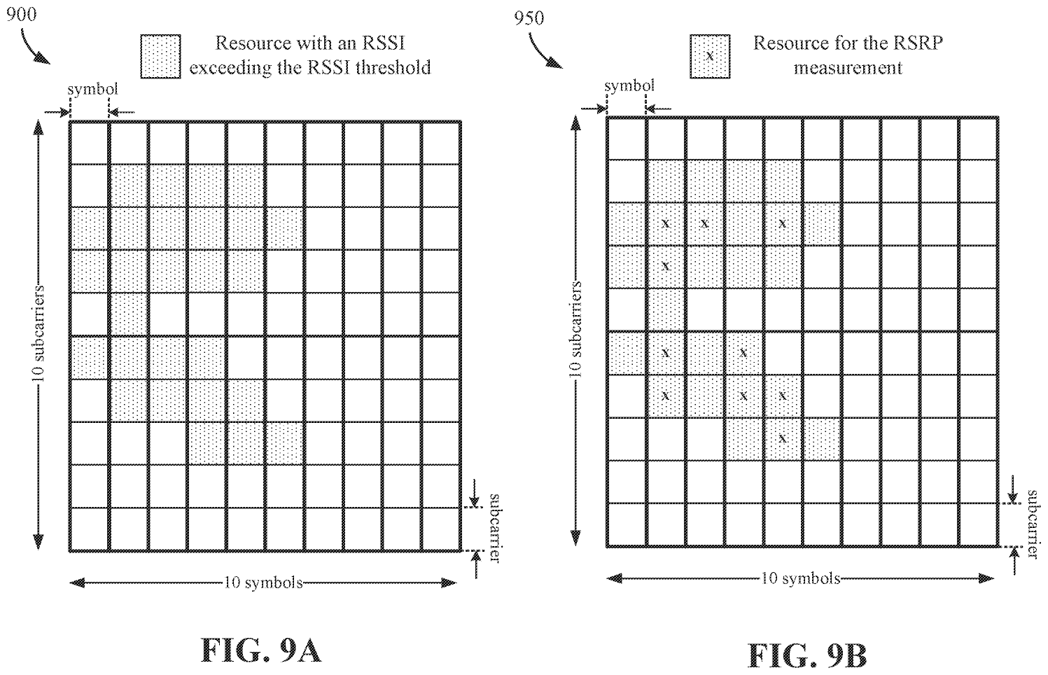

FIGS. 9A and 9B are example diagrams illustrating the use of the CLI measurement resources for the RSSI measurement and the RSRP measurement, according to some aspects. In the examples of FIGS. 9A and 9B, the UE is configured with 100 CLI measurement resources, defined by 10 symbols and 10 subcarriers. The CLI measurement resources may be SRS resources. Each subcarrier may correspond to an aggressor UE, and thus 10 subcarriers may respectively correspond to 10 aggressor UEs. FIG. 9A is an example diagram 900 illustrating the use of the CLI measurement resources where RSRP measurements are performed on all of the CLI measurement resources with RSSI values exceeding the threshold, according to some aspects. In FIG. 9A, the UE measures RSSI values on all of the 100 CLI measurement resources, and then determines that the RSSI values corresponding to the shaded resources exceed the RSSI threshold. Thus, the UE measures the RSRP values on the shaded resources and reports the RSRP values along with their resource indices. FIG. 9B is an example diagram 950 illustrating the use of the CLI measurement resources where RSRP measurements are performed on a subset of the CLI measurement resources with RSSI values exceeding the threshold, according to some aspects. In FIG. 9B, the UE measures RSSI values on all of the 100 CLI measurement resources, and then determines that the RSSI values corresponding to the shaded resources exceed the RSSI threshold. Then, the UE measures the RSRP values on 10 shaded resources (each marked with “x”) with top 10 RSSI values out of the RSSI values of the shaded resources, and reports the 10 RSRP values along with their resource indices.

In an aspect, the CLI measurement resources may be defined (e.g., by the base station) based on a number of symbols and a specific bandwidth, where one of more symbols may correspond to a respective aggressor UE. For example, the UE may measure a RSSI value per symbol of the CLI measurement resources, and then make RSRP measurements on symbols of the CLI measurement resources that are associated with RSSI values exceeding the RSSI threshold.

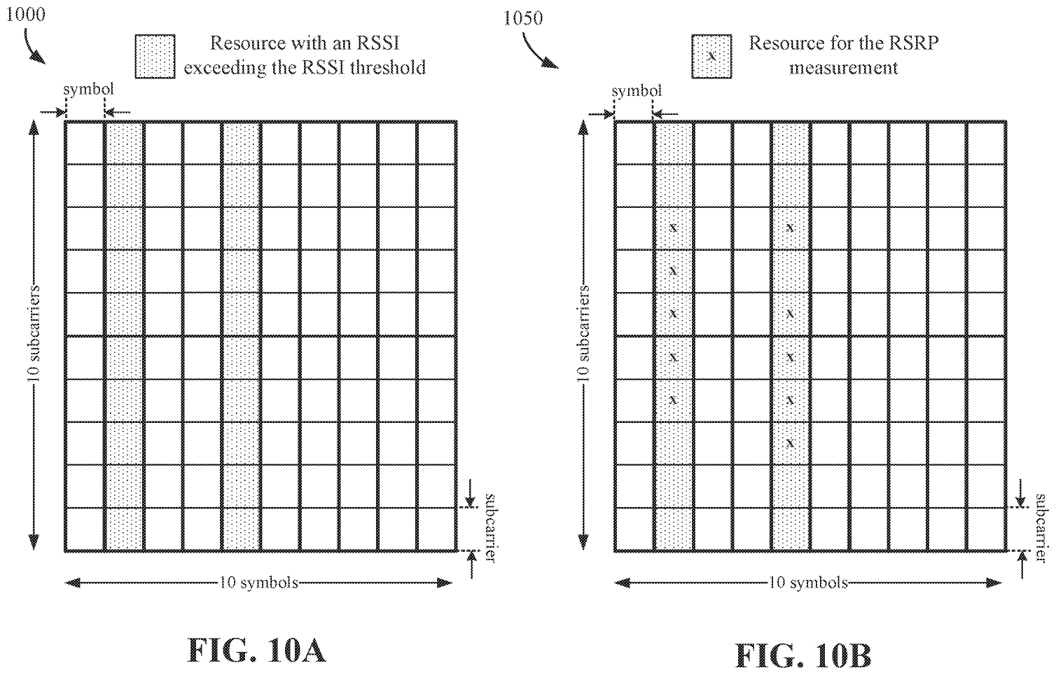

FIGS. 10A and 10B are example diagrams illustrating the use of the CLI measurement resources for the RSSI measurement and the RSRP measurement, according to some aspects. In the examples of FIGS. 10A and 10B, the UE is configured with 100 CLI measurement resources, defined by 10 symbols and 10 subcarriers. The CLI measurement resources may be SRS resources. Each subcarrier may correspond to an aggressor UE, and thus 10 subcarriers may respectively correspond to 10 aggressor UEs. FIG. 10A is an example diagram 1000 illustrating the use of the CLI measurement resources where RSRP measurements are performed on all of the CLI measurement resources with RSSI values exceeding the threshold, according to some aspects. In FIG. 10A, the UE measures RSSI values on 10 symbols of the CLI measurement resources, where each of the 10 symbols includes 10 CLI measurement resources, and then determines that the RSSI values corresponding to the second and fifth symbols exceed the RSSI threshold. 10 CLI measurement resources corresponding to the second symbol and 10 CLI measurement resources corresponding to the fifth symbol are shaded in FIG. 10A to indicate the RSSI values corresponding to the second symbol and the fifth symbol exceed the RSSI threshold. Thus, the UE measures 10 RSRP values respectively on the 10 CLI measurement resources corresponding to the second symbol and also measures 10 RSRP values respectively on the 10 CLI measurement resources corresponding to the fifth symbol. Then, the UE reports theses RSRP values along with their resource indices.

FIG. 10B is an example diagram 950 illustrating the use of the CLI measurement resources where RSRP measurements are performed on a subset of the CLI measurement resources with RSSI values exceeding the threshold, according to some aspects. In FIG. 10B, the UE measures RSSI values on 10 symbols of the CLI measurement resources, where each of the 10 symbols includes 10 CLI measurement resources, and then determines that the RSSI values corresponding to the second and fifth symbols exceed the RSSI threshold. 10 CLI measurement resources corresponding to the second symbol and 10 CLI measurement resources corresponding to the fifth symbol are shaded in FIG. 10A to indicate the RSSI values corresponding to the second symbol and the fifth symbol exceed the RSSI threshold. Then, the UE measures the RSRP values on 10 shaded resources (each marked with “x”) with top 10 RSSI values out of the RSSI values of the shaded resources in the second symbol and the fifth symbol, and reports the 10 RSRP values along with their resource indices.

In an aspect, the UE may transmit an RSSI measurement report including the one or more RSSI values exceeding the RSSI threshold and one or more CLI measurement resource indexes indicating the one or more CLI measurement resources. The RSSI measurement report may be transmitted prior to the RSRP measurement or may be transmitted after the RSRP measurement, e.g., together with the RSRP measurement report. In an aspect, the RSSI measurement report may merge the RSSI values within the same time frame (e.g., same symbol) or may merge the RSSI values within the same frequency unit (e.g., same subcarrier). The merging may take place by adding the RSSI values or calculating an average of the RSSI values, within the same time frame or within the same frequency unit. In an aspect, the RSRP measurement report may include RSRP values from the RSRP measurement that exceed an RSRP threshold and their respective CLI measurement resource indices.

In an aspect, if the base station receives the RSSI measurement report, the base station may transmit to the UE an RSRP measurement request requesting to perform an RSRP measurement on the at least one CLI measurement resource of the one or more CLI measurement resources, a number of the at least one CLI measurement resource being smaller less than or equal to a number of the one or more CLI measurement resources. In this aspect, the UE may measure the at least one RSRP value on the at least one CLI measurement resource in response to receiving the RSRP measurement request. In another aspect, the UE may autonomously select the at least one CLI measurement resource of the one or more CLI measurement resources for the RSRP measurement, without the RSRP measurement request, and may measure the at least one RSRP value in response to autonomously selecting the at least one CLI measurement resource.

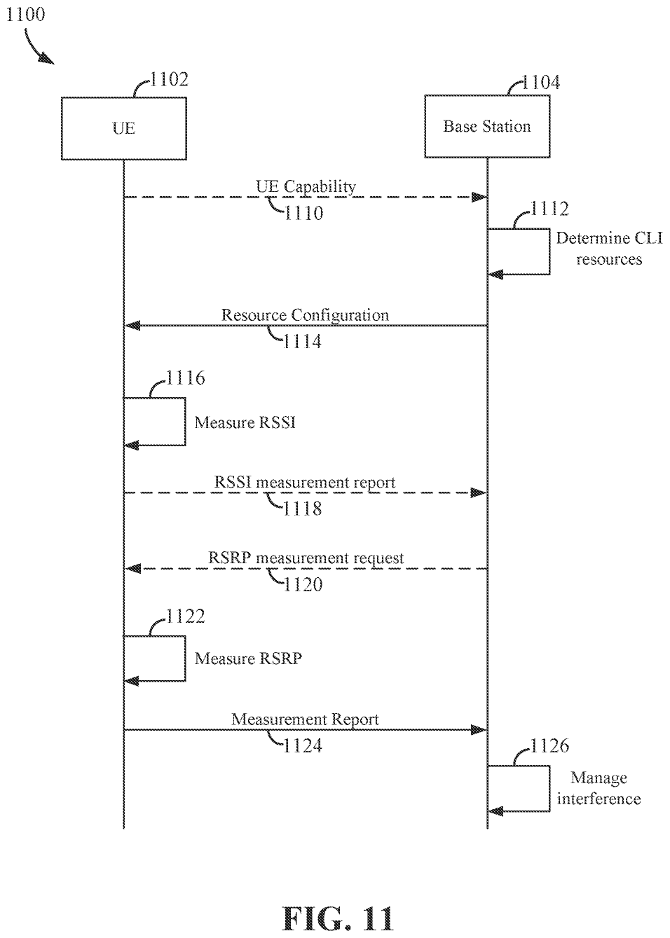

FIG. 11 is a flow diagram 1100 illustrating an exemplary process for measuring a CLI based on RSSI and RSRP measurements, according to some aspects. The CLI measurement procedure in FIG. 1 may be performed by a UE 1102 and a base station 1104. At 1110, in an aspect, the UE 1102 may transmit UE capability information to the base station 1104. The UE capability information may include the RSSI measurement resource capability information and/or the RSRP measurement resource capability information, where the RSSI measurement resource capability information may include one or more of the first number of CLI measurement resources on which the UE is capable of performing an RSSI measurement and an RSRP measurement, the second number of resources on which the UE is capable of performing at least the RSSI measurement, and the third number of RSSI resources on which the UE is capable of performing the RSSI measurement without the RSRP measurement, and the RSRP measurement resource capability may include the fourth number of RSRP resources for an RSRP measurement on which the UE 1102 is capable of performing the RSRP measurement. At 1112, the base station 1104 may determine CLI measurement resources that may be available for the RSSI measurement and the RSRP measurement. The CLI measurement resources may be determined based on the UE capability information. At 1114, the base station 1104 may transmit a resource configuration indicating the CLI measurement resources to the UE 1102.

At 1116, the UE 1102 measures RSSI values on the CLI measurement resources indicated in the resource configuration, and determines whether one or more RSSI values of the RSSI values exceed the RSSI threshold, where the one or more RSSI values are respectively associated with one or more CLI measurement resources of the CLI measurement resources. At 1118, in an aspect, the UE 1102 may transmit an RSSI measurement report including the one or more RSSI values exceeding the RSSI threshold and one or more CLI measurement resource indexes respectively indicating the one or more CLI measurement resources. At 1120, in an aspect, the UE 1102 may receive receiving an RSRP measurement request requesting to perform an RSRP measurement on the at least one CLI measurement resource of the one or more CLI measurement resources. The base station may transmit the RSRP measurement request the RSSI measurement report.

At 1122, the UE 1102 may measure at least one RSRP value respectively on at least one CLI measurement resource of the one or more CLI measurement resources in response to determining that the one or more RSSI values exceed the RSSI threshold. The UE 1102 may measure the at least one RSRP value in response to the RSRP measurement request or may autonomously measure the at least one RSRP value on the at least one CLI measurement resource without receiving the RSRP measurement request. At 1126, the UE 1102 may transmit a measurement report including the at least one RSRP value respectively associated with the at least one CLI measurement resource and further including at least one resource index respectively indicating the at least one CLI measurement resource. At 1126, the base station 1104 may determine and manage the CLI interference based on the RSRP measurement report and/or the RSSI measurement report, and may schedule the UE 1102 (e.g., and aggressor UEs) based on the RSRP measurement report and/or the RSSI measurement report.

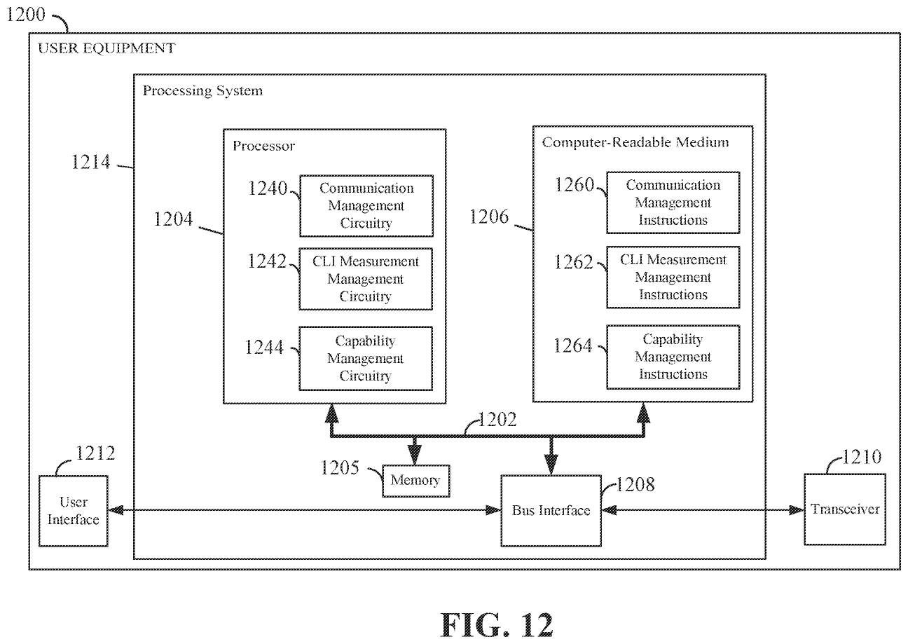

FIG. 12 is a block diagram illustrating an example of a hardware implementation for a user equipment (UE) 1200 employing a processing system 1214. For example, the UE 1200 may be a user equipment (UE) as illustrated in any one or more of FIGS. 1, 2, 3, 5, 6, 7, 8, and/or 11.

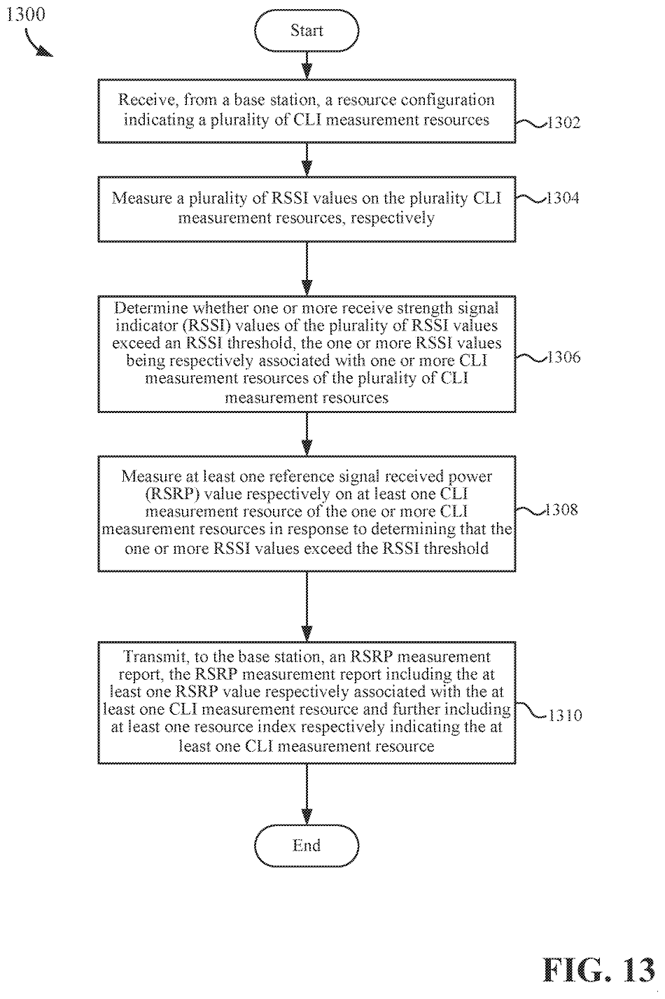

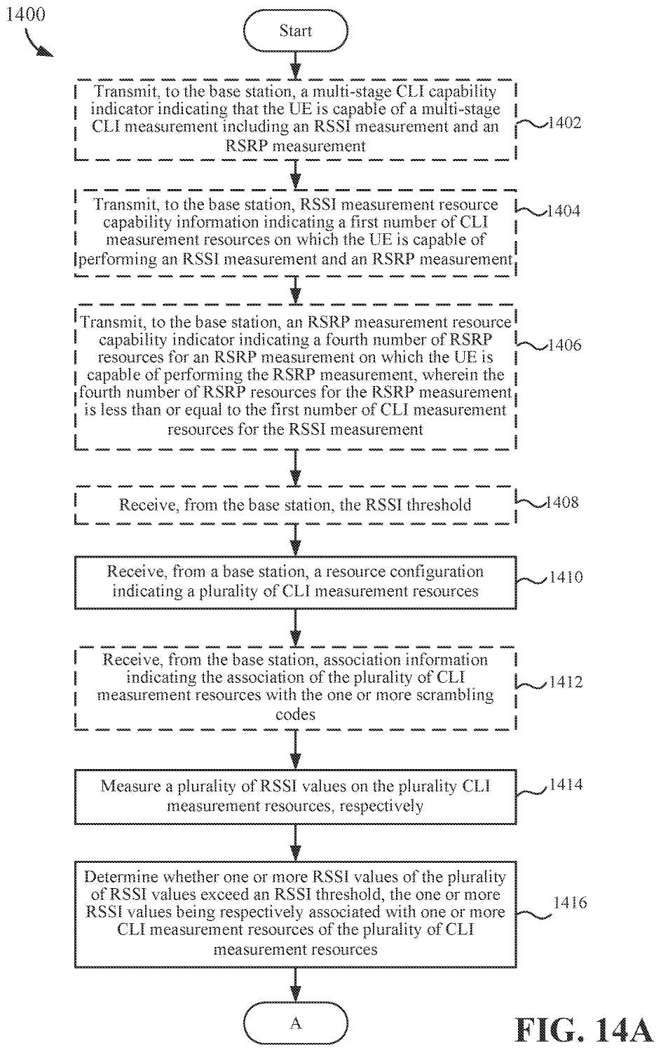

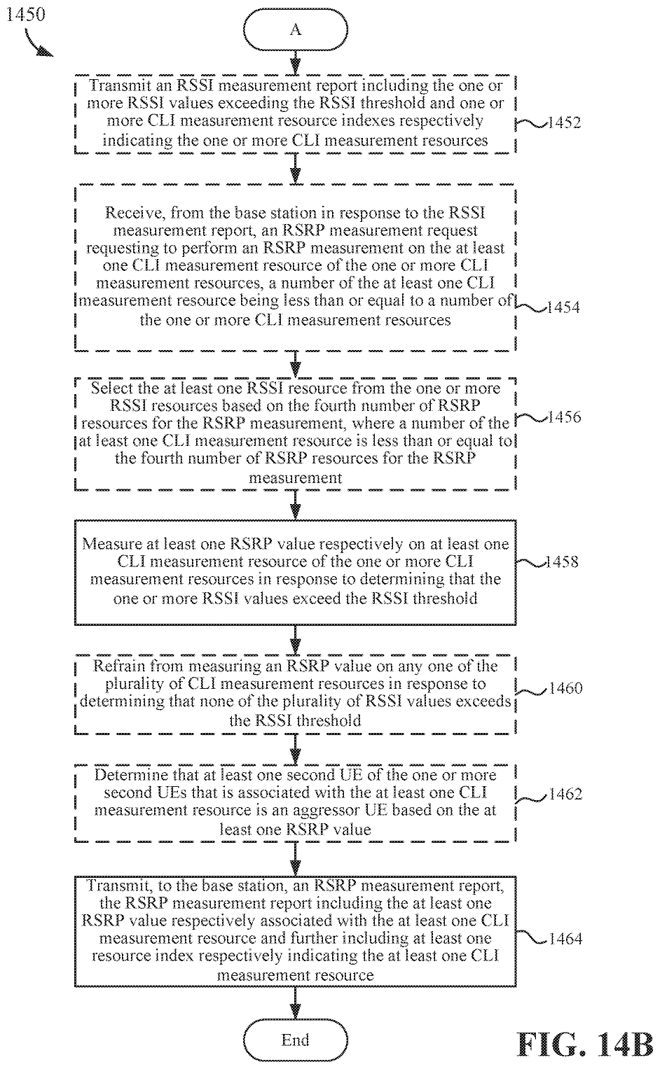

The UE 1200 may be implemented with a processing system 1214 that includes one or more processors 1204. Examples of processors 1204 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1200 may be configured to perform any one or more of the functions described herein. That is, the processor 1204, as utilized in a UE 1200, may be used to implement any one or more of the processes and procedures described below and illustrated in FIGS. 13-14.

In this example, the processing system 1214 may be implemented with a bus architecture, represented generally by the bus 1202. The bus 1202 may include any number of interconnecting buses and bridges depending on the specific application of the processing system 1214 and the overall design constraints. The bus 1202 communicatively couples together various circuits including one or more processors (represented generally by the processor 1204), a memory 1205, and computer-readable media (represented generally by the computer-readable storage medium 1206). The bus 1202 may also link various other circuits such as timing sources, peripherals, voltage regulators, and power management circuits, which are well known in the art, and therefore, will not be described any further. A bus interface 1208 provides an interface between the bus 1202 and a transceiver 1210. The transceiver 1210 provides a communication interface or means for communicating with various other apparatus over a transmission medium. Depending upon the nature of the apparatus, a user interface 1212 (e.g., keypad, display, speaker, microphone, joystick) may also be provided. Of course, such a user interface 1212 is optional, and may be omitted in some examples, such as a base station.

In some aspects of the disclosure, the processor 1204 may include communication management circuitry 1240 configured for various functions, including, for example, receiving, from a base station, a resource configuration indicating a plurality of CLI measurement resources. For example, the communication management circuitry 1240 may be configured to implement one or more of the functions described below in relation to FIGS. 13-14, including, e.g., blocks 1302 and 1410.

In some aspects, the communication management circuitry 1240 may be configured for various functions, including, for example, transmitting, to the base station, an RSRP measurement report, the RSRP measurement report including the at least one RSRP value respectively associated with the at least one CLI measurement resource and further including at least one resource index respectively indicating the at least one CLI measurement resource. For example, the communication management circuitry 1240 may be configured to implement one or more of the functions described below in relation to FIGS. 13-14, including, e.g., blocks 1310 and 1464.

In some aspects, the communication management circuitry 1240 may be configured for various functions, including, for example, receiving, from the base station, the RSSI threshold. For example, the communication management circuitry 1240 may be configured to implement one or more of the functions described below in relation to FIG. 14, including, e.g., block 1408.

In some aspects, the communication management circuitry 1240 may be configured for various functions, including, for example, receiving, from the base station, association information indicating the association of the plurality of CLI measurement resources with the one or more scrambling codes. For example, the communication management circuitry 1240 may be configured to implement one or more of the functions described below in relation to FIG. 14, including, e.g., block 1412.

In some aspects, the communication management circuitry 1240 may be configured for various functions, including, for example, transmitting an RSSI measurement report including the one or more RSSI values exceeding the RSSI threshold and one or more CLI measurement resource indexes respectively indicating the one or more CLI measurement resources. For example, the communication management circuitry 1240 may be configured to implement one or more of the functions described below in relation to FIG. 14, including, e.g., block 1452.

In some aspects, the communication management circuitry 1240 may be configured for various functions, including, for example, receiving, from the base station in response to the RSSI measurement report, an RSRP measurement request requesting to perform an RSRP measurement on the at least one CLI measurement resource of the one or more CLI measurement resources, a number of the at least one CLI measurement resource being less than or equal to a number of the one or more CLI measurement resources. For example, the communication management circuitry 1240 may be configured to implement one or more of the functions described below in relation to FIG. 14, including, e.g., block 1454.

In some aspects of the disclosure, the processor 1204 may include CLI measurement management circuitry 1242 configured for various functions, including, for example, measuring a plurality of RSSI values on the plurality of CLI measurement resources, respectively. For example, the CLI measurement management circuitry 1242 may be configured to implement one or more of the functions described below in relation to FIGS. 13-14, including, e.g., blocks 1304 and 1414.

In some aspects, the CLI measurement management circuitry 1242 may be configured for various functions, including, for example, determining whether one or more RSSI values of the plurality of RSSI values exceed an RSSI threshold, the one or more RSSI values being respectively associated with one or more CLI measurement resources of the plurality of CLI measurement resources. For example, the CLI measurement management circuitry 1242 may be configured to implement one or more of the functions described below in relation to FIGS. 13-14, including, e.g., blocks 1306 and 1416.

In some aspects, the CLI measurement management circuitry 1242 may be configured for various functions, including, for example, measuring at least one RSRP value respectively on at least one CLI measurement resource of the one or more CLI measurement resources in response to determining that the one or more RSSI values exceed the RSSI threshold. For example, the CLI measurement management circuitry 1242 may be configured to implement one or more of the functions described below in relation to FIGS. 13-14, including, e.g., blocks 1308 and 1458.

In some aspects, the CLI measurement management circuitry 1242 may be configured for various functions, including, for example, selecting the at least one RSSI resource from the one or more RSSI resources based on the fourth number of RSRP resources for the RSRP measurement, where a number of the at least one CLI measurement resource is less than or equal to the fourth number of RSRP resources for the RSRP measurement. For example, the CLI measurement management circuitry 1242 may be configured to implement one or more of the functions described below in relation to FIG. 14, including, e.g., block 1456.

In some aspects, the CLI measurement management circuitry 1242 may be configured for various functions, including, for example, refraining from measuring an RSRP value on any one of the plurality of CLI measurement resources in response to determining that none of the plurality of RSSI values exceeds the RSSI threshold. For example, the CLI measurement management circuitry 1242 may be configured to implement one or more of the functions described below in relation to FIG. 14, including, e.g., block 1460.

In some aspects, the CLI measurement management circuitry 1242 may be configured for various functions, including, for example, determining that at least one second UE of the one or more second UEs that is associated with the at least one CLI measurement resource is an aggressor UE based on the at least one RSRP value. For example, the CLI measurement management circuitry 1242 may be configured to implement one or more of the functions described below in relation to FIG. 14, including, e.g., block 1462.

In some aspects of the disclosure, the processor 1204 may include capability management circuitry 1244 configured for various functions, including, for example, transmitting, to the base station, a multi-stage CLI capability indicator indicating that the UE is capable of a multi-stage CLI measurement including an RSSI measurement and an RSRP measurement. For example, the capability management circuitry 1244 may be configured to implement one or more of the functions described below in relation to FIG. 14, including, e.g., block 1402.

In some aspects, the capability management circuitry 1244 may be configured for various functions, including, for example, transmitting, to the base station, RSSI measurement resource capability information indicating a first number of CLI measurement resources on which the UE is capable of performing an RSSI measurement and an RSRP measurement. For example, the capability management circuitry 1244 may be configured to implement one or more of the functions described below in relation to FIG. 14, including, e.g., block 1404.

In some aspects, the capability management circuitry 1244 may be configured for various functions, including, for example, transmitting, to the base station, an RSRP measurement resource capability indicator indicating a fourth number of RSRP resources for an RSRP measurement on which the UE is capable of performing the RSRP measurement, wherein the fourth number of RSRP resources for the RSRP measurement is less than or equal to the first number of CLI measurement resources for the RSSI measurement. For example, the capability management circuitry 1244 may be configured to implement one or more of the functions described below in relation to FIG. 14, including, e.g., block 1406.

The processor 1204 is responsible for managing the bus 1202 and general processing, including the execution of software stored on the computer-readable storage medium 1206. The software, when executed by the processor 1204, causes the processing system 1214 to perform the various functions described below for any particular apparatus. The computer-readable storage medium 1206 and the memory 1205 may also be used for storing data that is manipulated by the processor 1204 when executing software.

One or more processors 1204 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium 1206. The computer-readable storage medium 1206 may be a non-transitory computer-readable storage medium. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium 1206 may reside in the processing system 1214, external to the processing system 1214, or distributed across multiple entities including the processing system 1214. The computer-readable storage medium 1206 may be embodied in a computer program product. By way of example, a computer program product may include a computer-readable storage medium in packaging materials. Those skilled in the art will recognize how best to implement the described functionality presented throughout this disclosure depending on the particular application and the overall design constraints imposed on the overall system.

In some aspects of the disclosure, the computer-readable storage medium 1206 may include communication management software/instructions 1260 configured for various functions, including, for example, receiving, from a base station, a resource configuration indicating a plurality of CLI measurement resources. For example, the communication management software/instructions 1260 may be configured to implement one or more of the functions described below in relation to FIGS. 13-14, including, e.g., blocks 1302 and 1410.

In some aspects, the communication management software/instructions 1260 may be configured for various functions, including, for example, transmitting, to the base station, an RSRP measurement report, the RSRP measurement report including the at least one RSRP value respectively associated with the at least one CLI measurement resource and further including at least one resource index respectively indicating the at least one CLI measurement resource. For example, the communication management software/instructions 1260 may be configured to implement one or more of the functions described below in relation to FIGS. 13-14, including, e.g., blocks 1310 and 1464

In some aspects, the communication management software/instructions 1260 may be configured for various functions, including, for example, receiving, from the base station, the RSSI threshold. For example, the communication management software/instructions 1260 may be configured to implement one or more of the functions described below in relation to FIG. 14, including, e.g., block 1408.

In some aspects, the communication management software/instructions 1260 may be configured for various functions, including, for example, receiving, from the base station, association information indicating the association of the plurality of CLI measurement resources with the one or more scrambling codes. For example, the communication management software/instructions 1260 may be configured to implement one or more of the functions described below in relation to FIG. 14, including, e.g., block 1412.

In some aspects, the communication management software/instructions 1260 may be configured for various functions, including, for example, transmitting an RSSI measurement report including the one or more RSSI values exceeding the RSSI threshold and one or more CLI measurement resource indexes respectively indicating the one or more CLI measurement resources. For example, the communication management software/instructions 1260 may be configured to implement one or more of the functions described below in relation to FIG. 14, including, e.g., block 1452.

In some aspects, the communication management software/instructions 1260 may be configured for various functions, including, for example, receiving, from the base station in response to the RSSI measurement report, an RSRP measurement request requesting to perform an RSRP measurement on the at least one CLI measurement resource of the one or more CLI measurement resources, a number of the at least one CLI measurement resource being less than or equal to a number of the one or more CLI measurement resources. For example, the communication management software/instructions 1260 may be configured to implement one or more of the functions described below in relation to FIG. 14, including, e.g., block 1454.

In some aspects of the disclosure, the computer-readable storage medium 1206 may include CLI measurement management software/instructions 1262 configured for various functions, including, for example, measuring a plurality of RSSI values on the plurality of CLI measurement resources, respectively. For example, the CLI measurement management software/instructions 1262 may be configured to implement one or more of the functions described below in relation to FIGS. 13-14, including, e.g., blocks 1304 and 1414.

In some aspects, the CLI measurement management software/instructions 1262 may be configured for various functions, including, for example, determining whether one or more RSSI values of the plurality of RSSI values exceed an RSSI threshold, the one or more RSSI values being respectively associated with one or more CLI measurement resources of the plurality of CLI measurement resources. For example, the CLI measurement management software/instructions 1262 may be configured to implement one or more of the functions described below in relation to FIGS. 13-14, including, e.g., blocks 1306 and 1416.

In some aspects, the CLI measurement management software/instructions 1262 may be configured for various functions, including, for example, measuring at least one RSRP value respectively on at least one CLI measurement resource of the one or more CLI measurement resources in response to determining that the one or more RSSI values exceed the RSSI threshold. For example, the CLI measurement management software/instructions 1262 may be configured to implement one or more of the functions described below in relation to FIGS. 13-14, including, e.g., blocks 1308 and 1458.

In some aspects, the CLI measurement management software/instructions 1262 may be configured for various functions, including, for example, selecting the at least one RSSI resource from the one or more RSSI resources based on the fourth number of RSRP resources for the RSRP measurement, where a number of the at least one CLI measurement resource is less than or equal to the fourth number of RSRP resources for the RSRP measurement. For example, the CLI measurement management software/instructions 1262 may be configured to implement one or more of the functions described below in relation to FIG. 14, including. e.g., block 1456.

In some aspects, the CLI measurement management software/instructions 1262 may be configured for various functions, including, for example, refraining from measuring an RSRP value on any one of the plurality of CLI measurement resources in response to determining that none of the plurality of RSSI values exceeds the RSSI threshold. For example, the CLI measurement management software/instructions 1262 may be configured to implement one or more of the functions described below in relation to FIG. 14, including, e.g., block 1460.

In some aspects, the CLI measurement management software/instructions 1262 may be configured for various functions, including, for example, determining that at least one second UE of the one or more second UEs that is associated with the at least one CLI measurement resource is an aggressor UE based on the at least one RSRP value. For example, the CLI measurement management software/instructions 1262 may be configured to implement one or more of the functions described below in relation to FIG. 14, including, e.g., block 1462.

In some aspects of the disclosure, the computer-readable storage medium 1206 may include capability management software/instructions 1264 configured for various functions, including, for example, transmitting, to the base station, a multi-stage CLI capability indicator indicating that the UE is capable of a multi-stage CLI measurement including an RSSI measurement and an RSRP measurement. For example, the capability management software/instructions 1264 may be configured to implement one or more of the functions described below in relation to FIG. 14, including, e.g., block 1402.

In some aspects, the capability management software/instructions 1264 may be configured for various functions, including, for example, transmitting, to the base station, RSSI measurement resource capability information indicating a first number of CLI measurement resources on which the UE is capable of performing an RSSI measurement and an RSRP measurement. For example, the capability management software/instructions 1264 may be configured to implement one or more of the functions described below in relation to FIG. 14, including, e.g., block 1404.

In some aspects, the capability management software/instructions 1264 may be configured for various functions, including, for example, transmitting, to the base station, an RSRP measurement resource capability indicator indicating a fourth number of RSRP resources for an RSRP measurement on which the UE is capable of performing the RSRP measurement, wherein the fourth number of RSRP resources for the RSRP measurement is less than or equal to the first number of CLI measurement resources for the RSSI measurement. For example, the capability management software/instructions 1264 may be configured to implement one or more of the functions described below in relation to FIG. 14, including, e.g., block 1406.

FIG. 13 is a flow chart illustrating an exemplary process 1300 for measuring a CLI in accordance with some aspects of the present disclosure. As described below, some or all illustrated features may be omitted in a particular implementation within the scope of the present disclosure, and some illustrated features may not be required for implementation of all embodiments. In some examples, the process 1300 may be carried out by the UE 1200 illustrated in FIG. 12. In some examples, the process 1300 may be carried out by any suitable apparatus or means for carrying out the functions or algorithm described below.

At block 1302, the UE 1200 may receive, from a base station, a resource configuration indicating a plurality of CLI measurement resources. For example, the communication management circuitry 1240 shown and described above in connection with FIG. 12 may provide means for receiving the resource configuration.

At block 1304, the UE 1200 may measure a plurality of RSSI values on the plurality of CLI measurement resources, respectively. For example, the CLI measurement management circuitry 1242 shown and described above in connection with FIG. 12 may provide means for measuring the plurality of RSSI values.

At block 1306, the UE 1200 may determine whether one or more RSSI values of the plurality of RSSI values exceed an RSSI threshold, the one or more RSSI values being respectively associated with one or more CLI measurement resources of the plurality of CLI measurement resources. For example, the CLI measurement management circuitry 1242 shown and described above in connection with FIG. 12 may provide means for determining whether the one or more RSSI values of the plurality of RSSI values exceed the RSSI threshold.

At block 1308, the UE 1200 may measure at least one RSRP value respectively on at least one CLI measurement resource of the one or more CLI measurement resources in response to determining that the one or more RSSI values exceed the RSSI threshold. For example, the CLI measurement management circuitry 1242 shown and described above in connection with FIG. 12 may provide means for measuring the at least one RSRP value.

At block 1310, the UE 1200 may transmit, to the base station, an RSRP measurement report, the RSRP measurement report including the at least one RSRP value respectively associated with the at least one CLI measurement resource and further including at least one resource index respectively indicating the at least one CLI measurement resource. For example, the communication management circuitry 1240 shown and described above in connection with FIG. 12 may provide means for reporting the RSRP measurement report.

FIG. 14A is a flow chart illustrating an exemplary process 1400 for measuring a CLI in accordance with some aspects of the present disclosure. As described below, some or all illustrated features may be omitted in a particular implementation within the scope of the present disclosure, and some illustrated features may not be required for implementation of all embodiments. In some examples, the process 1400 may be carried out by the UE 1200 illustrated in FIG. 12. In some examples, the process 1400 may be carried out by any suitable apparatus or means for carrying out the functions or algorithm described below.

At block 1402, in an aspect, the UE 1200 may transmit, to the base station, a multi-stage CLI capability indicator indicating that the UE is capable of a multi-stage CLI measurement including an RSSI measurement and an RSRP measurement. For example, the capability management circuitry 1244 shown and described above in connection with FIG. 12 may provide means for transmitting the multi-stage CLI capability indicator.

At block 1404, in an aspect, the UE 1200 may transmit, to the base station, RSSI measurement resource capability information indicating a first number of CLI measurement resources on which the UE is capable of performing an RSSI measurement and an RSRP measurement. For example, the capability management circuitry 1244 shown and described above in connection with FIG. 12 may provide means for transmitting the RSSI measurement resource capability information. In an aspect, a number of the plurality of CLI measurement resources may be less than or equal to the first number of CLI measurement resources. In an aspect, the RSSI measurement resource capability information may further indicate at least one of a second number of resources on which the UE is capable of performing at least the RSSI measurement or a third number of RSSI resources on which the UE is capable of performing the RSSI measurement without the RSRP measurement.

In an aspect, the number of the plurality of CLI measurement resources may correspond to the first number of CLI measurement resources when the first number of CLI measurement resources is less than or equal to the second number of resources, and the number of the plurality of CLI measurement resources may correspond to the second number of CLI measurement resources when the first number of CLI measurement resources is greater than the second number of resources. In an aspect, the second number of resources for the RSSI measurement on which the UE is capable of performing at least the RSSI measurement may be greater than or equal to the third number, and the second number of resources for the RSSI measurement may be less than or equal to a sum of the third number of RSSI resources and the first number of CLI measurement resources.

At block 1406, in an aspect, the UE 1200 may transmit, to the base station, an RSRP measurement resource capability indicator indicating a fourth number of RSRP resources for an RSRP measurement on which the UE is capable of performing the RSRP measurement, where the fourth number of RSRP resources for the RSRP measurement is less than or equal to the first number of CLI measurement resources for the RSSI measurement. For example, the capability management circuitry 1244 shown and described above in connection with FIG. 12 may provide means for transmitting the RSRP measurement resource capability indicator.

At block 1408, in an aspect, the UE 1200 may receive, from the base station, the RSSI threshold. For example, the communication management circuitry 1240 shown and described above in connection with FIG. 12 may provide means for receiving the RSSI threshold.

At block 1410, the UE 1200 may receive, from a base station, a resource configuration indicating a plurality of CLI measurement resources. For example, the communication management circuitry 1240 shown and described above in connection with FIG. 12 may provide means for receiving the resource configuration.

In an aspect, the resource configuration indicating the plurality of CLI measurement resources may be received at 1410 in response to the multi-stage CLI capability indicator at 1402.

In an aspect, the plurality of CLI measurement resources may be associated with one or more scrambling codes that are respectively associated with one or more second UEs. At block 1412, in an aspect, the UE 1200 may receive, from the base station, association information indicating the association of the plurality of CLI measurement resources with the one or more scrambling codes. For example, the communication management circuitry 1240 shown and described above in connection with FIG. 12 may provide means for receiving the association information.

At block 1414, the UE 1200 may measure a plurality of RSSI values on the plurality of CLI measurement resources, respectively. For example, the CLI measurement management circuitry 1242 shown and described above in connection with FIG. 12 may provide means for measuring the plurality of RSSI values.

At block 1416, the UE 1200 may determine whether one or more RSSI values of the plurality of RSSI values exceed an RSSI threshold, the one or more RSSI values being respectively associated with one or more CLI measurement resources of the plurality of CLI measurement resources. For example, the CLI measurement management circuitry 1242 shown and described above in connection with FIG. 12 may provide means for determining whether the one or more RSSI values of the plurality of RSSI values exceed the RSSI threshold.

FIG. 14B is a flow chart illustrating an exemplary process 1450 for measuring a CLI continuing from the exemplary process 1400 of FIG. 14A, in accordance with some aspects. As described below, some or all illustrated features may be omitted in a particular implementation within the scope of the present disclosure, and some illustrated features may not be required for implementation of all embodiments. In some examples, the process 1450 may be carried out by the UE 1200 illustrated in FIG. 12. In some examples, the process 1450 may be carried out by any suitable apparatus or means for carrying out the functions or algorithm described below.

At block 1452, in an aspect, the UE 1200 may transmit an RSSI measurement report including the one or more RSSI values exceeding the RSSI threshold and one or more CLI measurement resource indexes indicating the one or more CLI measurement resources. For example, the communication management circuitry 1240 shown and described above in connection with FIG. 12 may provide means for transmitting the RSSI measurement report.

At block 1454, in an aspect, the UE 1200 may receive, from the base station in response to the RSSI measurement report, an RSRP measurement request requesting to perform an RSRP measurement on the at least one CLI measurement resource of the one or more CLI measurement resources, a number of the at least one CLI measurement resource being less than or equal to a number of the one or more CLI measurement resources. For example, the communication management circuitry 1240 shown and described above in connection with FIG. 12 may provide means for receiving the RSRP measurement request.

At block 1456, in an aspect, the UE 1200 may select the at least one RSSI resource from the one or more RSSI resources based on the fourth number of RSRP resources for the RSRP measurement, where a number of the at least one CLI measurement resource is less than or equal to the fourth number of RSRP resources for the RSRP measurement. For example, the CLI measurement management circuitry 1242 shown and described above in connection with FIG. 12 may provide means for selecting the at least one RSSI resource. In an aspect, each of the at least one CLI measurement resource selected from the one or more CLI measurement resources may be associated with an RSSI value greater than an RSSI value associated with each of a rest of the one or more CLI measurement resources different from the at least one CLI measurement resource.

At block 1458, the UE 1200 may measure at least one RSRP value respectively on at least one CLI measurement resource of the one or more CLI measurement resources in response to determining that the one or more RSSI values exceed the RSSI threshold. For example, the CLI measurement management circuitry 1242 shown and described above in connection with FIG. 12 may provide means for measuring the at least one RSRP value. In an aspect, measuring at block 1458 the at least one RSRP value on the at least one CLI measurement resource may include measuring the at least one RSRP value in response to receiving the RSRP measurement request at 1454.

At block 1460, in an aspect, the UE 1200 may refrain from measuring an RSRP value on any one of the plurality of CLI measurement resources in response to determining that none of the plurality of RSSI values exceeds the RSSI threshold. For example, the CLI measurement management circuitry 1242 shown and described above in connection with FIG. 12 may provide means for refraining from measuring an RSRP value.

At block 1462, in an aspect, the UE 1200 may determine that at least one second UE of the one or more second UEs that is associated with the at least one CLI measurement resource is an aggressor UE based on the at least one RSRP value. For example, the CLI measurement management circuitry 1242 shown and described above in connection with FIG. 12 may provide means for determining that the at least one second UE of the one or more second UEs is an aggressor UE.

At block 1464, the UE 1200 may transmit, to the base station, an RSRP measurement report, the RSRP measurement report including the at least one RSRP value respectively associated with the at least one CLI measurement resource and further including at least one resource index respectively indicating the at least one CLI measurement resource. For example, the communication management circuitry 1240 shown and described above in connection with FIG. 12 may provide means for reporting the RSRP measurement report.

In one configuration, the UE 1200 for wireless communication includes means for receiving, from a base station, a resource configuration indicating a plurality of CLI measurement resources; measuring a plurality of receive strength signal indicator (RSSI) values on the plurality of CLI measurement resources, respectively; means for determining whether one or more RSSI values of the plurality of RSSI values exceed an RSSI threshold, the one or more RSSI values being respectively associated with one or more CLI measurement resources of the plurality of CLI measurement resources; means for measuring at least one reference signal received power (RSRP) value respectively on at least one CLI measurement resource of the one or more CLI measurement resources in response to determining that the one or more RSSI values exceed the RSSI threshold; and means for transmitting, to the base station, an RSRP measurement report, the RSRP measurement report including the at least one RSRP value respectively associated with the at least one CLI measurement resource and further including at least one resource index respectively indicating the at least one CLI measurement resource.

In an aspect, the UE 1200 may include means for refraining from measuring an RSRP value on any one of the plurality of CLI measurement resources in response to determining that none of the plurality of RSSI values exceeds the RSSI threshold. In an aspect, the UE 1200 may include means for transmitting, to the base station, RSSI measurement resource capability information indicating a first number of CLI measurement resources on which the UE is capable of performing an RSSI measurement and an RSRP measurement. In an aspect, the UE 1200 may include means for transmitting, to the base station, an RSRP measurement resource capability information indicating a fourth number of RSRP resources for an RSRP measurement on which the UE is capable of performing the RSRP measurement. In an aspect, the UE 1200 may include means for selecting the at least one CLI measurement resource from the one or more CLI measurement resources based on the fourth number of RSRP resources for the RSRP measurement, wherein a number of the at least one CLI measurement resource is less than or equal to the fourth number of RSRP resources for the RSRP measurement. In an aspect, the UE 1200 may include means for transmitting, to the base station, a multi-stage CLI capability indicator indicating that the UE is capable of a multi-stage CLI measurement including an RSSI measurement and an RSRP measurement. In an aspect, the UE 1200 may include means for transmitting an RSSI measurement report including the one or more RSSI values exceeding the RSSI threshold and one or more CLI measurement resource indexes respectively indicating the one or more CLI measurement resources. In an aspect, the UE 1200 may include means for receiving, from the base station, the RSSI threshold. In an aspect, the UE 1200 may include means for receiving, from the base station, association information indicating the association of the plurality of CLI measurement resources with the one or more scrambling codes, and means for determining that at least one second UE of the one or more second UEs that is associated with the at least one CLI measurement resource is an aggressor UE based on the at least one RSRP value.

In one aspect, the aforementioned means may be the processor(s) 1204 shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1, 2, 3, 5, 6, 7, 8, and/or 11, and utilizing, for example, the processes and/or algorithms described herein in relation to FIGS. 13 and/or 14.

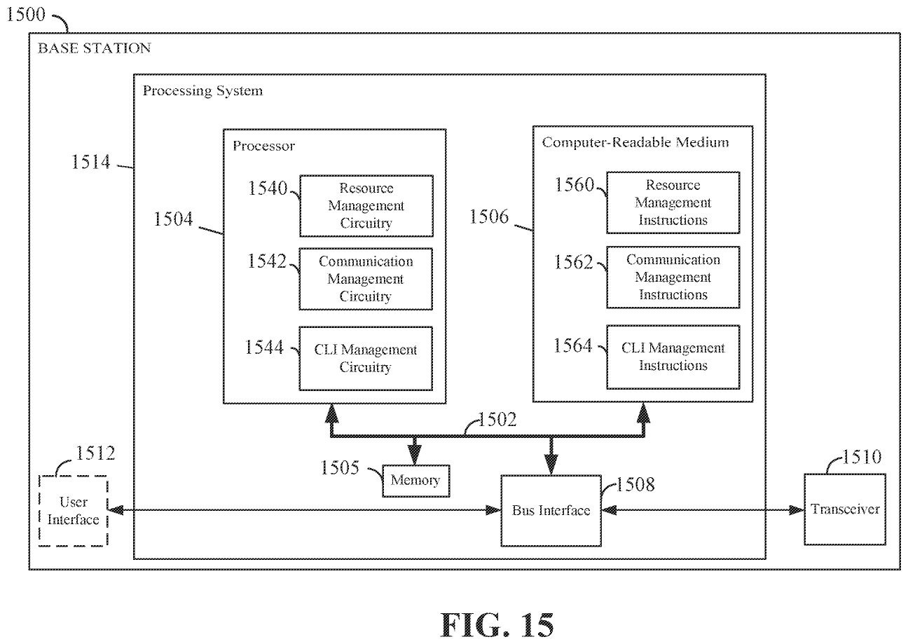

FIG. 15 is a conceptual diagram illustrating an example of a hardware implementation for an exemplary base station 1500 employing a processing system 1514. In accordance with various aspects of the disclosure, an element, or any portion of an element, or any combination of elements may be implemented with a processing system 1514 that includes one or more processors 1504. For example, the base station 1500 may be a user equipment (UE) as illustrated in any one or more of FIGS. 1, 2, and/or 3.

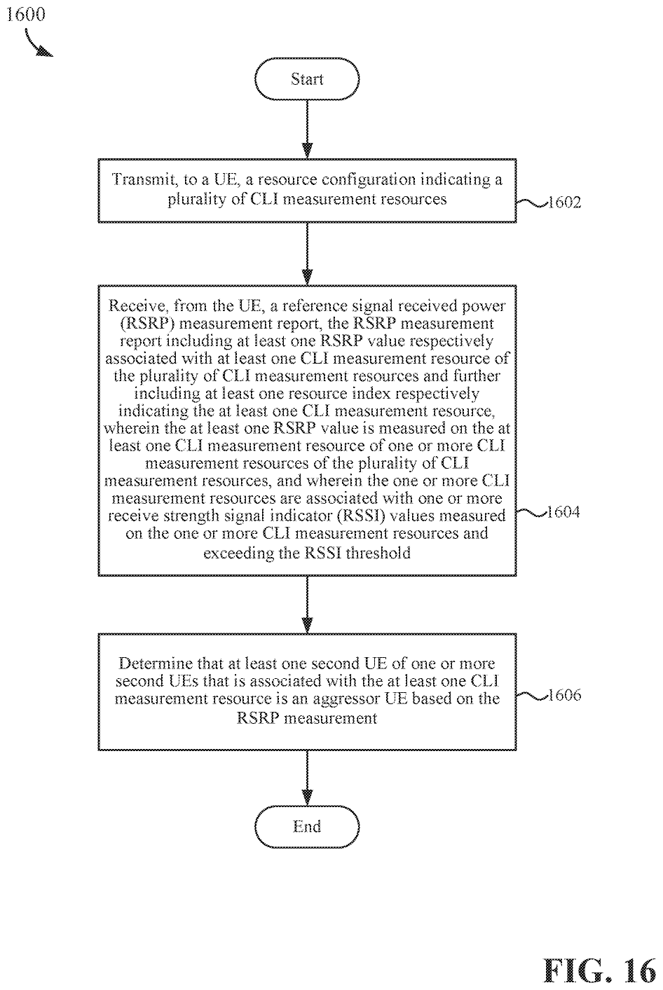

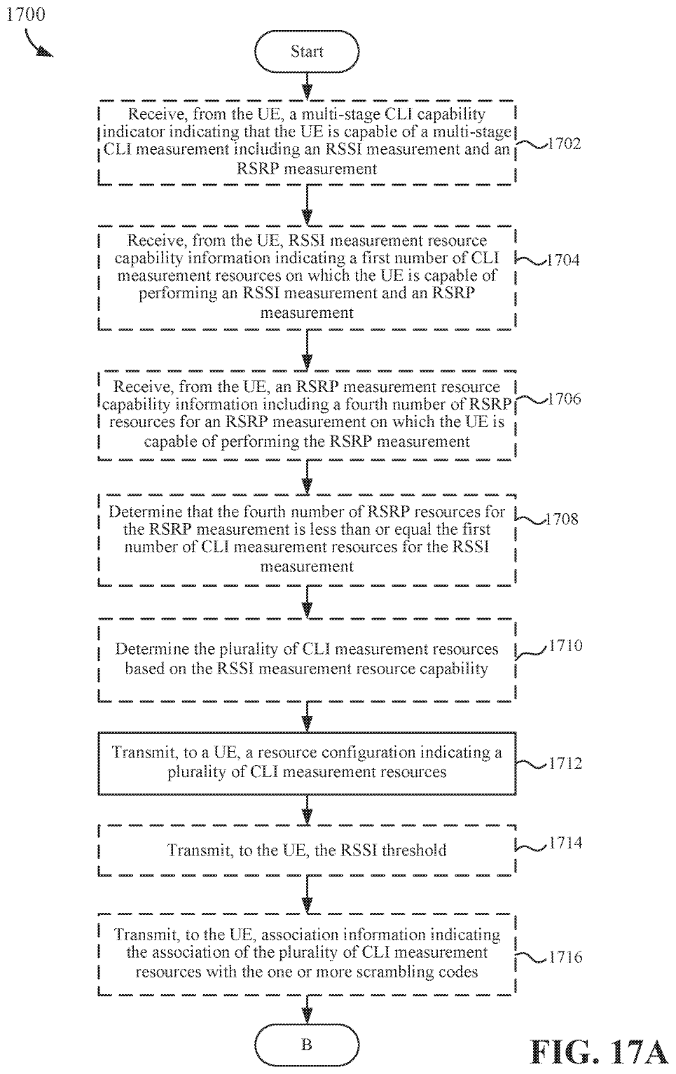

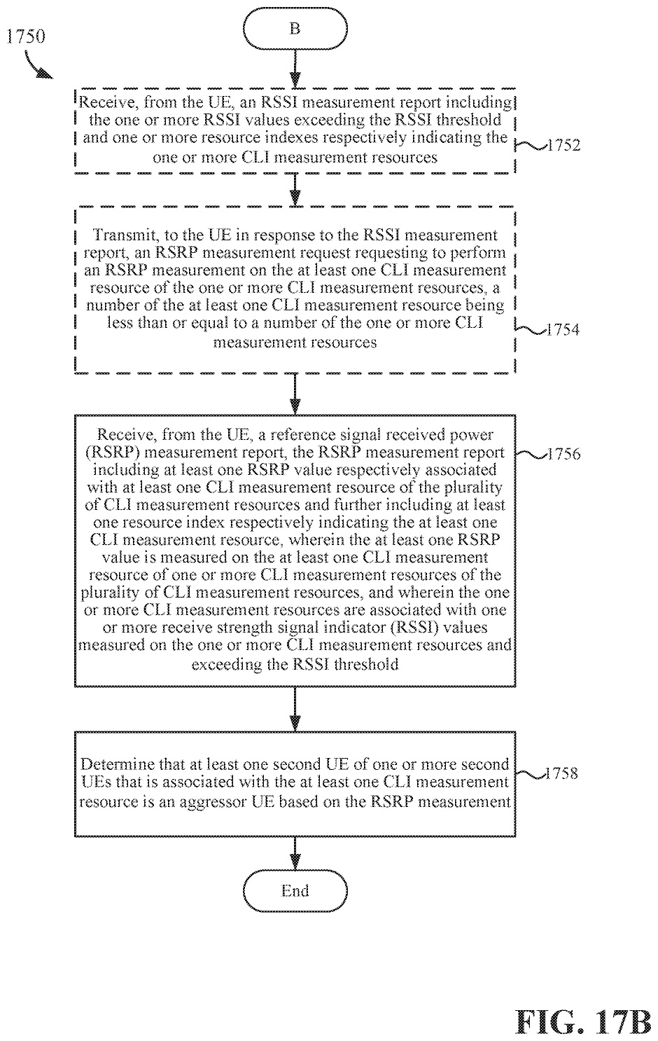

The processing system 1514 may be substantially the same as the processing system 1214 illustrated in FIG. 12, including a bus interface 1508, a bus 1502, memory 1505, a processor 1504, and a computer-readable storage medium 1506. Furthermore, the base station 1500 may include a user interface 1512 and a transceiver 1510 substantially similar to those described above in FIG. 12. That is, the processor 1504, as utilized in a base station 1500, may be used to implement any one or more of the processes described below and illustrated in FIGS. 16-17.

In some aspects of the disclosure, the processor 1504 may include resource management circuitry 1540 configured for various functions, including, for example, transmitting, to a UE, a resource configuration indicating a plurality of CLI measurement resources. For example, the resource management circuitry 1540 may be configured to implement one or more of the functions described below in relation to FIGS. 16-17, including, e.g., blocks 1602 and 1712.

In some aspects, the resource management circuitry 1540 may be configured for various functions, including, for example, receiving, from the UE, RSSI measurement resource capability information indicating a first number of CLI measurement resources on which the UE is capable of performing an RSSI measurement and an RSRP measurement. For example, the resource management circuitry 1540 may be configured to implement one or more of the functions described below in relation to FIG. 17, including, e.g., block 1704.

In some aspects, the resource management circuitry 1540 may be configured for various functions, including, for example, receiving, from the UE, an RSRP measurement resource capability information including a fourth number of RSRP resources for an RSRP measurement on which the UE is capable of performing the RSRP measurement. For example, the resource management circuitry 1540 may be configured to implement one or more of the functions described below in relation to FIG. 17, including, e.g., block 1706.

In some aspects, the resource management circuitry 1540 may be configured for various functions, including, for example, determining that the fourth number of RSRP resources for the RSRP measurement is less than or equal the first number of CLI measurement resources for the RSSI measurement. For example, the resource management circuitry 1540 may be configured to implement one or more of the functions described below in relation to FIG. 17, including, e.g., block 1708.

In some aspects, the resource management circuitry 1540 may be configured for various functions, including, for example, determining the plurality of CLI measurement resources based on the RSSI measurement resource capability. For example, the resource management circuitry 1540 may be configured to implement one or more of the functions described below in relation to FIG. 17, including, e.g., block 1710.

In some aspects of the disclosure, the processor 1504 may include communication management circuitry 1542 configured for various functions, including, for example, receiving, from the UE, a RSRP measurement report, the RSRP measurement report including at least one RSRP value respectively associated with at least one CLI measurement resource of the plurality of CLI measurement resources and further including at least one resource index respectively indicating the at least one CLI measurement resource. For example, the communication management circuitry 1542 may be configured to implement one or more of the functions described below in relation to FIGS. 16-17, including, e.g., blocks 1604 and 1756.

In some aspects, the communication management circuitry 1542 may be configured for various functions, including, for example, receiving, from the UE, a multi-stage CLI capability indicator indicating that the UE is capable of a multi-stage CLI measurement including an RSSI measurement and an RSRP measurement For example, the communication management circuitry 1542 may be configured to implement one or more of the functions described below in relation to FIG. 17, including, e.g., block 1702.

In some aspects, the communication management circuitry 1542 may be configured for various functions, including, for example, transmitting, to the UE, the RSSI threshold. For example, the communication management circuitry 1542 may be configured to implement one or more of the functions described below in relation to FIG. 17, including, e.g., block 1714.

In some aspects, the communication management circuitry 1542 may be configured for various functions, including, for example, receiving, from the UE, an RSSI measurement report including the one or more RSSI values exceeding the RSSI threshold and one or more resource indexes respectively indicating the one or more CLI measurement resources. For example, the communication management circuitry 1542 may be configured to implement one or more of the functions described below in relation to FIG. 17, including, e.g., block 1752.

In some aspects, the communication management circuitry 1542 may be configured for various functions, including, for example, transmitting, to the UE in response to the RSSI measurement report, an RSRP measurement request requesting to perform an RSRP measurement on the at least one CLI measurement resource of the one or more CLI measurement resources, a number of the at least one CLI measurement resource being less than or equal to a number of the one or more CLI measurement resources. For example, the communication management circuitry 1542 may be configured to implement one or more of the functions described below in relation to FIG. 17, including, e.g., block 1754.

In some aspects of the disclosure, the processor 1504 may include CLI management circuitry 1544 configured for various functions, including, for example, determining that at least one second UE of one or more second UEs that is associated with the at least one CLI measurement resource is an aggressor UE based on the RSRP measurement. For example, the CLI management circuitry 1544 may be configured to implement one or more of the functions described below in relation to FIGS. 16-17, including, e.g., blocks 1606 and 1758.

In some aspects of the disclosure, the computer-readable storage medium 1506 may include resource management software/instructions 1560 configured for various functions, including, for example, transmitting, to a UE, a resource configuration indicating a plurality of CLI measurement resources. For example, the resource management software/instructions 1560 may be configured to implement one or more of the functions described below in relation to FIGS. 16-17, including, e.g., blocks 1602 and 1712.

In some aspects, the resource management software/instructions 1560 may be configured for various functions, including, for example, receiving, from the UE. RSSI measurement resource capability information indicating a first number of CLI measurement resources on which the UE is capable of performing an RSSI measurement and an RSRP measurement. For example, the resource management software/instructions 1560 may be configured to implement one or more of the functions described below in relation to FIG. 17, including, e.g., block 1704.

In some aspects, the resource management software/instructions 1560 may be configured for various functions, including, for example, receiving, from the UE, an RSRP measurement resource capability information including a fourth number of RSRP resources for an RSRP measurement on which the UE is capable of performing the RSRP measurement. For example, the resource management software/instructions 1560 may be configured to implement one or more of the functions described below in relation to FIG. 17, including, e.g., block 1706.

In some aspects, the resource management software/instructions 1560 may be configured for various functions, including, for example, determining that the fourth number of RSRP resources for the RSRP measurement is less than or equal the first number of CLI measurement resources for the RSSI measurement. For example, the resource management software/instructions 1560 may be configured to implement one or more of the functions described below in relation to FIG. 17, including, e.g., block 1708.

In some aspects, the resource management software/instructions 1560 may be configured for various functions, including, for example, determining the plurality of CLI measurement resources based on the RSSI measurement resource capability. For example, the resource management software/instructions 1560 may be configured to implement one or more of the functions described below in relation to FIG. 17, including, e.g., block 1710.

In some aspects of the disclosure, the computer-readable storage medium 1506 may include communication management software/instructions 1562 configured for various functions, including, for example, receiving, from the UE, a RSRP measurement report, the RSRP measurement report including at least one RSRP value respectively associated with at least one CLI measurement resource of the plurality of CLI measurement resources and further including at least one resource index respectively indicating the at least one CLI measurement resource. For example, the communication management software/instructions 1562 may be configured to implement one or more of the functions described below in relation to FIGS. 16-17, including, e.g., blocks 1604 and 1756.

In some aspects, the communication management software/instructions 1562 may be configured for various functions, including, for example, receiving, from the UE, a multi-stage CLI capability indicator indicating that the UE is capable of a multi-stage CLI measurement including an RSSI measurement and an RSRP measurement For example, the communication management software/instructions 1562 may be configured to implement one or more of the functions described below in relation to FIG. 17, including, e.g., block 1702.

In some aspects, the communication management software/instructions 1562 may be configured for various functions, including, for example, transmitting, to the UE, the RSSI threshold. For example, the communication management software/instructions 1562 may be configured to implement one or more of the functions described below in relation to FIG. 17, including, e.g., block 1714.

In some aspects, the communication management software/instructions 1562 may be configured for various functions, including, for example, receiving, from the UE, an RSSI measurement report including the one or more RSSI values exceeding the RSSI threshold and one or more resource indexes respectively indicating the one or more CLI measurement resources. For example, the communication management software/instructions 1562 may be configured to implement one or more of the functions described below in relation to FIG. 17, including, e.g., block 1752.

In some aspects, the communication management software/instructions 1562 may be configured for various functions, including, for example, transmitting, to the UE in response to the RSSI measurement report, an RSRP measurement request requesting to perform an RSRP measurement on the at least one CLI measurement resource of the one or more CLI measurement resources, a number of the at least one CLI measurement resource being less than or equal to a number of the one or more CLI measurement resources. For example, the communication management software/instructions 1562 may be configured to implement one or more of the functions described below in relation to FIG. 17, including, e.g., block 1754.

In some aspects of the disclosure, the computer-readable storage medium 1506 may include CLI management software/instructions 1564 configured for various functions, including, for example, determining that at least one second UE of one or more second UEs that is associated with the at least one CLI measurement resource is an aggressor UE based on the RSRP measurement. For example, the CLI management software/instructions 1564 may be configured to implement one or more of the functions described below in relation to FIGS. 16-17, including, e.g., blocks 1606 and 1758.

FIG. 16 is a flow chart illustrating an exemplary process 1600 for identifying at least one aggressor UE causing a CLI, in accordance with some aspects. As described below, some or all illustrated features may be omitted in a particular implementation within the scope of the present disclosure, and some illustrated features may not be required for implementation of all embodiments. In some examples, the process 1600 may be carried out by the base station 1500 illustrated in FIG. 15. In some examples, the process 1600 may be carried out by any suitable apparatus or means for carrying out the functions or algorithm described below.

At block 1602, the base station 1500 may transmit, to a UE, a resource configuration indicating a plurality of CLI measurement resources. For example, the resource management circuitry 1540 shown and described above in connection with FIG. 15 may provide means for transmitting the resource configuration.

At block 1604, the base station 1500 may receive, from the UE, an RSRP measurement report, the RSRP measurement report including at least one RSRP value respectively associated with at least one CLI measurement resource of the plurality of CLI measurement resources and further including at least one resource index respectively indicating the at least one CLI measurement resource, wherein the at least one RSRP value is measured on the at least one CLI measurement resource of one or more CLI measurement resources of the plurality of CLI measurement resources, and wherein the one or more CLI measurement resources are associated with one or more RSSI values measured on the one or more CLI measurement resources and exceeding the RSSI threshold. For example, the communication management circuitry 1542 shown and described above in connection with FIG. 15 may provide means for receiving the RSRP measurement report.

At block 1606, the base station 1500 may determine that at least one second UE of one or more second UEs that is associated with the at least one CLI measurement resource is an aggressor UE based on the RSRP measurement report. For example, the CLI management circuitry 1544 shown and described above in connection with FIG. 15 may provide means for determining that the at least one second UE is an aggressor UE.

FIG. 17A is a flow chart illustrating an exemplary process 1700 for identifying at least one aggressor UE causing a CLI in accordance with some aspects of the present disclosure. As described below, some or all illustrated features may be omitted in a particular implementation within the scope of the present disclosure, and some illustrated features may not be required for implementation of all embodiments. In some examples, the process 1700 may be carried out by the base station 1500 illustrated in FIG. 15. In some examples, the process 1700 may be carried out by any suitable apparatus or means for carrying out the functions or algorithm described below.

At block 1702, in an aspect, the base station 1500 may receive, from the UE, a multi-stage CLI capability indicator indicating that the UE is capable of a multi-stage CLI measurement including an RSSI measurement and an RSRP measurement. For example, the communication management circuitry 1542 shown and described above in connection with FIG. 15 may provide means for receiving the multi-stage CLI capability indicator.

At block 1704, in an aspect, the base station 1500 may receive, from the UE, RSSI measurement resource capability information indicating a first number of CLI measurement resources on which the UE is capable of performing an RSSI measurement and an RSRP measurement. For example, the resource management circuitry 1540 shown and described above in connection with FIG. 15 may provide means for receiving the RSSI measurement resource capability information.

At block 1706, in an aspect, the base station 1500 may receive, from the UE, an RSRP measurement resource capability information including a fourth number of RSRP resources for an RSRP measurement on which the UE is capable of performing the RSRP measurement. For example, the resource management circuitry 1540 shown and described above in connection with FIG. 15 may provide means for receiving the RSRP measurement resource capability information.

In an aspect, the RSSI measurement resource capability information may further indicate at least one of a second number of resources on which the UE is capable of performing at least the RSSI measurement or a third number of RSSI resources on which the UE is capable of performing the RSSI measurement without the RSRP measurement. In an aspect, the number of the plurality of CLI measurement resources may correspond to the first number of CLI measurement resources when the first number of CLI measurement resources is less than or equal to the second number of resources, and the number of the plurality of CLI measurement resources may correspond to the second number of CLI measurement resources when the first number of CLI measurement resources is greater than the second number of resources. In an aspect, the second number of resources for the RSSI measurement on which the UE is capable of performing the RSSI measurement may be greater than or equal to the third number, and the second number of resources for the RSSI measurement may be less than or equal to the sum of the third number of RSSI resources and the first number of CLI measurement resources.

At block 1708, in an aspect, the base station 1500 may determine that the fourth number of RSRP resources for the RSRP measurement is less than or equal the first number of CLI measurement resources for the RSSI measurement. For example, the resource management circuitry 1540 shown and described above in connection with FIG. 15 may provide means for determining that the fourth number of RSRP resources for the RSRP measurement is less than or equal the first number of CLI measurement resources for the RSSI measurement.

At block 1710, in an aspect, the base station 1500 may determine the plurality of CLI measurement resources based on the RSSI measurement resource capability. For example, the resource management circuitry 1540 shown and described above in connection with FIG. 15 may provide means for determining the plurality of CLI measurement resources. In an aspect, a number of the plurality of CLI measurement resources may be less than or equal to the first number of CLI measurement resources.

In an aspect, determining at block 1710 the plurality of CLI measurement resources may include determining the plurality of CLI measurement resources in response to determining that the fourth number of RSRP resources for the RSRP measurement is less than or equal to the first number of CLI measurement resources at 1708.

In an aspect, the at least one CLI measurement resource may be selected from the one or more CLI measurement resources based on the fourth number of RSRP resources for the RSRP measurement, wherein a number of the at least one CLI measurement resource is less than or equal to the fourth number of RSRP resources for the RSRP measurement. In an aspect, each of the at least one CLI measurement resource selected from the one or more CLI measurement resources may be associated with an RSSI value greater than an RSSI value associated with each of a rest of the one or more CLI measurement resources different from the at least one CLI measurement resource.

At block 1712, the base station 1500 may transmit, to a UE, a resource configuration indicating a plurality of CLI measurement resources. For example, the resource management circuitry 1540 shown and described above in connection with FIG. 15 may provide means for transmitting the resource configuration.

In an aspect, the resource configuration indicating the plurality of CLI measurement resources may be transmitted at 1712 in response to the multi-stage CLI capability indicator.

At block 1714, in an aspect, the base station 1500 may transmit, to the UE, the RSSI threshold. For example, the communication management circuitry 1542 shown and described above in connection with FIG. 15 may provide means for transmitting the RSSI threshold.

In an aspect, the plurality of CLI measurement resources may be associated with one or more scrambling codes that are respectively associated with one or more second UEs. At block 1716, in an aspect, the base station 1500 may transmit, to the UE, association information indicating the association of the plurality of CLI measurement resources with the one or more scrambling codes. For example, the communication management circuitry 1542 shown and described above in connection with FIG. 15 may provide means for transmitting the association information. In an aspect, at least one second UE of the one or more second UEs that is associated with the at least one CLI measurement resource may be an aggressor UE based on the at least one RSRP value.

FIG. 17B is a flow chart illustrating an exemplary process 1750 for identifying at least one aggressor UE causing the CLI continuing from the exemplary process 1750 of FIG. 17A, in accordance with some aspects. As described below, some or all illustrated features may be omitted in a particular implementation within the scope of the present disclosure, and some illustrated features may not be required for implementation of all embodiments. In some examples, the process 1750 may be carried out by the base station 1500 illustrated in FIG. 15. In some examples, the process 1700 may be carried out by any suitable apparatus or means for carrying out the functions or algorithm described below.

At block 1752, in an aspect, the base station 1500 may receive, from the UE, an RSSI measurement report including the one or more RSSI values exceeding the RSSI threshold and one or more resource indexes respectively indicating the one or more CLI measurement resources. For example, the communication management circuitry 1542 shown and described above in connection with FIG. 15 may provide means for receiving the RSSI measurement report.

At block 1754, in an aspect, the base station 1500 may transmit, to the UE in response to the RSSI measurement report, an RSRP measurement request requesting to perform an RSRP measurement on the at least one CLI measurement resource of the one or more CLI measurement resources, a number of the at least one CLI measurement resource being less than or equal to a number of the one or more CLI measurement resources. For example, the communication management circuitry 1542 shown and described above in connection with FIG. 15 may provide means for transmitting the RSSI measurement report. In an aspect, the at least one RSRP value may be measured on the at least one CLI measurement resource based on the RSRP measurement request.

At block 1756, the base station 1500 may receive, from the UE, an RSRP measurement report, the RSRP measurement report including at least one RSRP value respectively associated with at least one CLI measurement resource of the plurality of CLI measurement resources and further including at least one resource index respectively indicating the at least one CLI measurement resource, wherein the at least one RSRP value is measured on the at least one CLI measurement resource of one or more CLI measurement resources of the plurality of CLI measurement resources, and wherein the one or more CLI measurement resources are associated with one or more RSSI values measured on the one or more CLI measurement resources and exceeding the RSSI threshold. For example, the communication management circuitry 1542 shown and described above in connection with FIG. 15 may provide means for receiving the RSRP measurement report.

At block 1758, the base station 1500 may determine that at least one second UE of one or more second UEs that is associated with the at least one CLI measurement resource is an aggressor UE based on the RSRP measurement report. For example, the CLI management circuitry 1544 shown and described above in connection with FIG. 15 may provide means for determining that the at least one second UE is an aggressor UE.

In one configuration, the base station 1500 for wireless communication includes means for transmitting, to a UE, a resource configuration indicating a plurality of CLI measurement resources, means for receiving, from the UE, a RSRP measurement report, the RSRP measurement report including at least one RSRP value respectively associated with at least one CLI measurement resource of the plurality of CLI measurement resources and further including at least one resource index respectively indicating the at least one CLI measurement resource, wherein the at least one RSRP value is measured on the at least one CLI measurement resource of one or more CLI measurement resources of the plurality of CLI measurement resources, and wherein the one or more CLI measurement resources are associated with one or more RSSI values measured on the one or more CLI measurement resources and exceeding the RSSI threshold, and means for determining that at least one second UE of one or more second UEs that is associated with the at least one CLI measurement resource is an aggressor UE based on the RSRP measurement report.

In an aspect, the base station 1500 may further include means for receiving, from the UE, RSSI measurement resource capability information indicating a first number of CLI measurement resources on which the UE is capable of performing an RSSI measurement and an RSRP measurement, and means for determining the plurality of CLI measurement resources based on the RSSI measurement resource capability. In an aspect, the base station 1500 may further include means for receiving, from the UE, an RSRP measurement resource capability information including a fourth number of RSRP resources for an RSRP measurement on which the UE is capable of performing the RSRP measurement, and means for determining that the fourth number of RSRP resources for the RSRP measurement is less than or equal the first number of CLI measurement resources for the RSSI measurement. In an aspect, the base station 1500 may further include means for receiving, from the UE, a multi-stage CLI capability indicator indicating that the UE is capable of a multi-stage CLI measurement including an RSSI measurement and an RSRP measurement.

In an aspect, the base station 1500 may further include means for receiving, from the UE, an RSSI measurement report including the one or more RSSI values exceeding the RSSI threshold and one or more resource indexes respectively indicating the one or more CLI measurement resources. In an aspect, the base station 1500 may further include means for transmitting, to the UE in response to the RSSI measurement report, an RSRP measurement request requesting to perform an RSRP measurement on the at least one CLI measurement resource of the one or more CLI measurement resources, a number of the at least one CLI measurement resource being less than or equal to a number of the one or more CLI measurement resources. In an aspect, the base station 1500 may further include means for transmitting, to the UE, the RSSI threshold. In an aspect, the base station 1500 may further include means for transmitting, to the UE, association information indicating the association of the plurality of CLI measurement resources with the one or more scrambling codes.

In one aspect, the aforementioned means may be the processor(s) 1504 shown in FIG. 15 configured to perform the functions recited by the aforementioned means. In another aspect, the aforementioned means may be a circuit or any apparatus configured to perform the functions recited by the aforementioned means.

Of course, in the above examples, the circuitry included in the processor 1504 is merely provided as an example, and other means for carrying out the described functions may be included within various aspects of the present disclosure, including but not limited to the instructions stored in the computer-readable storage medium 1506, or any other suitable apparatus or means described in any one of the FIGS. 1, 2, 3, 5, 6, 7, 8, and/or 11, and utilizing, for example, the processes and/or algorithms described herein in relation to FIGS. 16 and/or 17.

The following provides an overview of several aspects of the present disclosure.

Aspect 1: A method of measuring a cross link interference (CLI) by a user equipment (UE), comprising: receiving, from a base station, a resource configuration indicating a plurality of CLI measurement resources, measuring a plurality of receive strength signal indicator (RSSI) values on the plurality of CLI measurement resources, respectively, determining whether one or more RSSI values of the plurality of RSSI values exceed an RSSI threshold, the one or more RSSI values being respectively associated with one or more CLI measurement resources of the plurality of CLI measurement resources, measuring at least one reference signal received power (RSRP) value respectively on at least one CLI measurement resource of the one or more CLI measurement resources in response to determining that the one or more RSSI values exceed the RSSI threshold, and transmitting, to the base station, an RSRP measurement report, the RSRP measurement report including the at least one RSRP value respectively associated with the at least one CLI measurement resource and further including at least one resource index respectively indicating the at least one CLI measurement resource.

Aspect 2: The method of claim 1, further comprising: refraining from measuring an RSRP value on any one of the plurality of CLI measurement resources in response to determining that none of the plurality of RSSI values exceeds the RSSI threshold.

Aspect 3: The method of claim 1 or 2, further comprising: transmitting, to the base station, RSSI measurement resource capability information indicating a first number of CLI measurement resources on which the UE is capable of performing an RSSI measurement and an RSRP measurement, wherein a number of the plurality of CLI measurement resources is less than or equal to the first number of CLI measurement resources.

Aspect 4: The method of claim 3, wherein the RSSI measurement resource capability information further indicates at least one of a second number of resources on which the UE is capable of performing at least the RSSI measurement or a third number of RSSI resources on which the UE is capable of performing the RSSI measurement without the RSRP measurement.

Aspect 5: The method of claim 4, wherein the number of the plurality of CLI measurement resources corresponds to the first number of CLI measurement resources when the first number of CLI measurement resources is less than or equal to the second number of resources, and wherein the number of the plurality of CLI measurement resources corresponds to the second number of CLI measurement resources when the first number of CLI measurement resources is greater than the second number of resources.

Aspect 6: The method of claim 4 or 5, wherein the second number of resources for the RSSI measurement on which the UE is capable of performing at least the RSSI measurement is greater than or equal to the third number, and wherein the second number of resources for the RSSI measurement is less than or equal to a sum of the third number of RSSI resources and the first number of CLI measurement resources.

Aspect 7: The method of any of claims 3 through 6, further comprising: transmitting, to the base station, an RSRP measurement resource capability information indicating a fourth number of RSRP resources for an RSRP measurement on which the UE is capable of performing the RSRP measurement, wherein the fourth number of RSRP resources for the RSRP measurement is less than or equal to the first number of CLI measurement resources for the RSSI measurement.

Aspect 8: The method of claim 7, further comprising: selecting the at least one CLI measurement resource from the one or more CLI measurement resources based on the fourth number of RSRP resources for the RSRP measurement, wherein a number of the at least one CLI measurement resource is less than or equal to the fourth number of RSRP resources for the RSRP measurement.

Aspect 9: The method of claim 8, wherein each of the at least one CLI measurement resource selected from the one or more CLI measurement resources is associated with an RSSI value greater than an RSSI value associated with each of a rest of the one or more CLI measurement resources different from the at least one CLI measurement resource.

Aspect 10: The method of any of claims 1 through 9, further comprising: transmitting, to the base station, a multi-stage CLI capability indicator indicating that the UE is capable of a multi-stage CLI measurement including an RSSI measurement and an RSRP measurement, wherein the resource configuration indicating the plurality of CLI measurement resources is received in response to the multi-stage CLI capability indicator.

Aspect 11: The method of any of claims 1 through 10, further comprising: transmitting an RSSI measurement report including the one or more RSSI values exceeding the RSSI threshold and one or more CLI measurement resource indexes respectively indicating the one or more CLI measurement resources.

Aspect 12: The method of claim 11, further comprising: receiving, from the base station in response to the RSSI measurement report, an RSRP measurement request requesting to perform an RSRP measurement on the at least one CLI measurement resource of the one or more CLI measurement resources, a number of the at least one CLI measurement resource being smaller than or equal to a number of the one or more CLI measurement resources, wherein measuring the at least one RSRP value on the at least one CLI measurement resource comprises measuring the at least one RSRP value in response to receiving the RSRP measurement request.

Aspect 13: The method of any of claims 1 through 12, further comprising: receiving, from the base station, the RSSI threshold.

Aspect 14: The method of any of claims 1 through 13, wherein the plurality of CLI measurement resources are associated with one or more scrambling codes that are respectively associated with one or more second UEs.

Aspect 15: The method of claim 14, further comprising: receiving, from the base station, association information indicating the association of the plurality of CLI measurement resources with the one or more scrambling codes, and determining that at least one second UE of the one or more second UEs that is associated with the at least one CLI measurement resource is an aggressor UE based on the at least one RSRP value.

Aspect 16: A UE comprising: a transceiver configured to communicate with a radio access network, a memory, and a processor communicatively coupled to the transceiver and the memory, wherein the processor and the memory are configured to perform any one of aspects 1 through 15.

Aspect 17: A UE configured for wireless communication comprising at least one means for performing any one of aspects 1 through 15.

Aspect 18: A non-transitory processor-readable storage medium having instructions for a UE thereon, wherein the instructions, when executed by a processing circuit, cause the processing circuit to perform any one of aspects 1 through 15.

Aspect 19: A method of identifying at least one aggressor UE causing a cross link interference (CLI) by a base station, comprising: transmitting, to a UE, a resource configuration indicating a plurality of CLI measurement resources, receiving, from the UE, a reference signal received power (RSRP) measurement report, the RSRP measurement report including at least one RSRP value respectively associated with at least one CLI measurement resource of the plurality of CLI measurement resources and further including at least one resource index respectively indicating the at least one CLI measurement resource, wherein the at least one RSRP value is measured on the at least one CLI measurement resource of one or more CLI measurement resources of the plurality of CLI measurement resources, and wherein the one or more CLI measurement resources are associated with one or more receive strength signal indicator (RSSI) values measured on the one or more CLI measurement resources and exceeding the RSSI threshold, and determining that at least one second UE of one or more second UEs that is associated with the at least one CLI measurement resource is an aggressor UE based on the RSRP measurement report.

Aspect 20: The method of claim 19, further comprising: receiving, from the UE. RSSI measurement resource capability information indicating a first number of CLI measurement resources on which the UE is capable of performing an RSSI measurement and an RSRP measurement, and determining the plurality of CLI measurement resources based on the RSSI measurement resource capability, wherein a number of the plurality of CLI measurement resources is less than or equal to the first number of CLI measurement resources.

Aspect 21: The method of claim 20, wherein the RSSI measurement resource capability information further indicates at least one of a second number of resources on which the UE is capable of performing at least the RSSI measurement or a third number of RSSI resources on which the UE is capable of performing the RSSI measurement without the RSRP measurement.

Aspect 22: The method of claim 21, wherein the number of the plurality of CLI measurement resources corresponds to the first number of CLI measurement resources when the first number of CLI measurement resources is less than or equal to the second number of resources, and wherein the number of the plurality of CLI measurement resources corresponds to the second number of CLI measurement resources when the first number of CLI measurement resources is greater than the second number of resources.

Aspect 23: The method of claim 21 or 22, wherein the second number of resources for the RSSI measurement on which the UE is capable of performing the RSSI measurement is greater than or equal to the third number, and wherein the second number of resources for the RSSI measurement is less than or equal to the sum of the third number of RSSI resources and the first number of CLI measurement resources.

Aspect 24: The method of any of claims 20 through 23, further comprising: receiving, from the UE, an RSRP measurement resource capability information including a fourth number of RSRP resources for an RSRP measurement on which the UE is capable of performing the RSRP measurement, and determining that the fourth number of RSRP resources for the RSRP measurement is less than or equal the first number of CLI measurement resources for the RSSI measurement, wherein determining the plurality of CLI measurement resources comprises determining the plurality of CLI measurement resources in response to determining that the fourth number of RSRP resources for the RSRP measurement is less than or equal to the first number of CLI measurement resources.

Aspect 25: The method of claim 24, wherein the at least one CLI measurement resource is selected from the one or more CLI measurement resources based on the fourth number of RSRP resources for the RSRP measurement, wherein a number of the at least one CLI measurement resource is less than or equal to the fourth number of RSRP resources for the RSRP measurement.

Aspect 26: The method of claim 25, wherein each of the at least one CLI measurement resource selected from the one or more CLI measurement resources is associated with an RSSI value greater than an RSSI value associated with each of a rest of the one or more CLI measurement resources different from the at least one CLI measurement resource.

Aspect 27: The method of any of claims 19 through 26, further comprising: receiving, from the UE, a multi-stage CLI capability indicator indicating that the UE is capable of a multi-stage CLI measurement including an RSSI measurement and an RSRP measurement, wherein the resource configuration indicating the plurality of CLI measurement resources is transmitted in response to the multi-stage CLI capability indicator.

Aspect 28: The method of any of claims 19 through 27, further comprising: receiving, from the UE, an RSSI measurement report including the one or more RSSI values exceeding the RSSI threshold and one or more resource indexes respectively indicating the one or more CLI measurement resources.

Aspect 29: The method of claim 28, further comprising: transmitting, to the UE in response to the RSSI measurement report, an RSRP measurement request requesting to perform an RSRP measurement on the at least one CLI measurement resource of the one or more CLI measurement resources, a number of the at least one CLI measurement resource being less than or equal to a number of the one or more CLI measurement resources, wherein the at least one RSRP value is measured on the at least one CLI measurement resource based on the RSRP measurement request:

Aspect 30: The method of claim any of claims 19 through 29, further comprising: transmitting, to the UE, the RSSI threshold.

Aspect 31: The method of claim any of claims 19 through 30, wherein the plurality of CLI measurement resources are associated with one or more scrambling codes that are respectively associated with one or more second UEs.

Aspect 32: The method of claim 31, further comprising: transmitting, to the UE, association information indicating the association of the plurality of CLI measurement resources with the one or more scrambling codes, wherein at least one second UE of the one or more second UEs that is associated with the at least one CLI measurement resource is an aggressor UE based on the at least one RSRP value.

Aspect 33: A base station comprising: a transceiver configured to communicate with a radio access network, a memory, and a processor communicatively coupled to the transceiver and the memory, wherein the processor and the memory are configured to perform any one of aspects 19 through 32.

Aspect 34: A base station configured for wireless communication comprising at least one means for performing any one of aspects 19 through 32.

Aspect 35: A non-transitory processor-readable storage medium having instructions for a base station thereon, wherein the instructions, when executed by a processing circuit, cause the processing circuit to perform any one of aspects 19 through 32.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20. Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-17 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-17 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example. “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of measuring a cross link interference (CLI) by a user equipment (UE), comprising:
receiving, from a base station, a resource configuration indicating a plurality of CLI measurement resources;
measuring a plurality of receive strength signal indicator (RSSI) values on the plurality of CLI measurement resources, respectively;
determining whether one or more RSSI values of the plurality of RSSI values exceed an RSSI threshold, the one or more RSSI values being respectively associated with one or more CLI measurement resources of the plurality of CLI measurement resources;
measuring at least one reference signal received power (RSRP) value respectively on at least one CLI measurement resource of the one or more CLI measurement resources in response to determining that the one or more RSSI values exceed the RSSI threshold; and
transmitting, to the base station, an RSRP measurement report, the RSRP measurement report including the at least one RSRP value respectively associated with the at least one CLI measurement resource and further including at least one resource index respectively indicating the at least one CLI measurement resource.

2. The method of claim 1, further comprising:
refraining from measuring an RSRP value on any one of the plurality of CLI measurement resources in response to determining that none of the plurality of RSSI values exceeds the RSSI threshold.

3. The method of claim 1, further comprising:
transmitting, to the base station, RSSI measurement resource capability information indicating a first number of CLI measurement resources on which the UE is capable of performing an RSSI measurement and an RSRP measurement,
wherein a number of the plurality of CLI measurement resources is less than or equal to the first number of CLI measurement resources.

4. The method of claim 3, wherein the RSSI measurement resource capability information further indicates at least one of a second number of resources on which the UE is capable of performing at least the RSSI measurement or a third number of RSSI resources on which the UE is capable of performing the RSSI measurement without the RSRP measurement.

5. The method of claim 4, wherein the number of the plurality of CLI measurement resources corresponds to the first number of CLI measurement resources when the first number of CLI measurement resources is less than or equal to the second number of resources, and
wherein the number of the plurality of CLI measurement resources corresponds to the second number of CLI measurement resources when the first number of CLI measurement resources is greater than the second number of resources.

6. The method of claim 4, wherein the second number of resources for the RSSI measurement on which the UE is capable of performing at least the RSSI measurement is greater than or equal to the third number, and
wherein the second number of resources for the RSSI measurement is less than or equal to a sum of the third number of RSSI resources and the first number of CLI measurement resources.

7. The method of claim 3, further comprising:
transmitting, to the base station, an RSRP measurement resource capability information indicating a fourth number of RSRP resources for an RSRP measurement on which the UE is capable of performing the RSRP measurement, wherein the fourth number of RSRP resources for the RSRP measurement is less than or equal to the first number of CLI measurement resources for the RSSI measurement.

8. The method of claim 7, further comprising:
selecting the at least one CLI measurement resource from the one or more CLI measurement resources based on the fourth number of RSRP resources for the RSRP measurement, wherein a number of the at least one CLI measurement resource is less than or equal to the fourth number of RSRP resources for the RSRP measurement.

9. The method of claim 8, wherein each of the at least one CLI measurement resource selected from the one or more CLI measurement resources is associated with an RSSI value greater than an RSSI value associated with each of a rest of the one or more CLI measurement resources different from the at least one CLI measurement resource.

10. The method of claim 1, further comprising:
transmitting, to the base station, a multi-stage CLI capability indicator indicating that the UE is capable of a multi-stage CLI measurement including an RSSI measurement and an RSRP measurement,
wherein the resource configuration indicating the plurality of CLI measurement resources is received in response to the multi-stage CLI capability indicator.

11. The method of claim 1, further comprising:
transmitting an RSSI measurement report including the one or more RSSI values exceeding the RSSI threshold and one or more CLI measurement resource indexes respectively indicating the one or more CLI measurement resources.

12. The method of claim 11, further comprising:
receiving, from the base station in response to the RSSI measurement report, an RSRP measurement request requesting to perform an RSRP measurement on the at least one CLI measurement resource of the one or more CLI measurement resources, a number of the at least one CLI measurement resource being smaller than or equal to a number of the one or more CLI measurement resources,
wherein measuring the at least one RSRP value on the at least one CLI measurement resource comprises measuring the at least one RSRP value in response to receiving the RSRP measurement request.

13. The method of claim 1, wherein the plurality of CLI measurement resources are associated with one or more scrambling codes that are respectively associated with one or more second UEs.

14. The method of claim 13, further comprising:
receiving, from the base station, association information indicating the association of the plurality of CLI measurement resources with the one or more scrambling codes; and
determining that at least one second UE of the one or more second UEs that is associated with the at least one CLI measurement resource is an aggressor UE based on the at least one RSRP value.

15. A user equipment (UE) for measuring a cross link interference (CLI), comprising:
at least one processor;
a transceiver communicatively coupled to the at least one processor; and
a memory communicatively coupled to the at least one processor,
wherein the at least one processor is configured to:
receive, from a base station, a resource configuration indicating a plurality of CLI measurement resources;
measure a plurality of receive strength signal indicator (RSSI) values on the plurality of CLI measurement resources, respectively;
determine whether one or more RSSI values of the plurality of RSSI values exceed an RSSI threshold, the one or more RSSI values being respectively associated with one or more CLI measurement resources of the plurality of CLI measurement resources;
measure at least one reference signal received power (RSRP) value respectively on at least one CLI measurement resource of the one or more CLI measurement resources in response to determining that the one or more RSSI values exceed the RSSI threshold; and
transmit, to the base station, an RSRP measurement report, the RSRP measurement report including the at least one RSRP value respectively associated with the at least one CLI measurement resource and further including at least one resource index respectively indicating the at least one CLI measurement resource.

16. A method of identifying at least one aggressor UE causing a cross link interference (CLI) by a base station, comprising:
transmitting, to a UE, a resource configuration indicating a plurality of CLI measurement resources;
receiving, from the UE, a reference signal received power (RSRP) measurement report, the RSRP measurement report including at least one RSRP value respectively associated with at least one CLI measurement resource of the plurality of CLI measurement resources and further including at least one resource index respectively indicating the at least one CLI measurement resource, wherein the at least one RSRP value is measured on the at least one CLI measurement resource of one or more CLI measurement resources of the plurality of CLI measurement resources, and wherein the one or more CLI measurement resources are associated with one or more receive strength signal indicator (RSSI) values measured on the one or more CLI measurement resources and exceeding the RSSI threshold; and
determining that at least one second UE of one or more second UEs that is associated with the at least one CLI measurement resource is an aggressor UE based on the RSRP measurement report.

17. The method of claim 16, further comprising:
receiving, from the UE, RSSI measurement resource capability information indicating a first number of CLI measurement resources on which the UE is capable of performing an RSSI measurement and an RSRP measurement; and
determining the plurality of CLI measurement resources based on the RSSI measurement resource capability,
wherein a number of the plurality of CLI measurement resources is less than or equal to the first number of CLI measurement resources.

18. The method of claim 17, wherein the RSSI measurement resource capability information further indicates at least one of a second number of resources on which the UE is capable of performing at least the RSSI measurement or a third number of RSSI resources on which the UE is capable of performing the RSSI measurement without the RSRP measurement.

19. The method of claim 18, wherein the number of the plurality of CLI measurement resources corresponds to the first number of CLI measurement resources when the first number of CLI measurement resources is less than or equal to the second number of resources, and
wherein the number of the plurality of CLI measurement resources corresponds to the second number of CLI measurement resources when the first number of CLI measurement resources is greater than the second number of resources.

20. The method of claim 18, wherein the second number of resources for the RSSI measurement on which the UE is capable of performing the RSSI measurement is greater than or equal to the third number, and
wherein the second number of resources for the RSSI measurement is less than or equal to the sum of the third number of RSSI resources and the first number of CLI measurement resources.

21. The method of claim 17, further comprising:
receiving, from the UE, an RSRP measurement resource capability information including a fourth number of RSRP resources for an RSRP measurement on which the UE is capable of performing the RSRP measurement; and
determining that the fourth number of RSRP resources for the RSRP measurement is less than or equal the first number of CLI measurement resources for the RSSI measurement,
wherein determining the plurality of CLI measurement resources comprises determining the plurality of CLI measurement resources in response to determining that the fourth number of RSRP resources for the RSRP measurement is less than or equal to the first number of CLI measurement resources.

22. The method of claim 21, wherein the at least one CLI measurement resource is selected from the one or more CLI measurement resources based on the fourth number of RSRP resources for the RSRP measurement, wherein a number of the at least one CLI measurement resource is less than or equal to the fourth number of RSRP resources for the RSRP measurement.

23. The method of claim 22, wherein each of the at least one CLI measurement resource selected from the one or more CLI measurement resources is associated with an RSSI value greater than an RSSI value associated with each of a rest of the one or more CLI measurement resources different from the at least one CLI measurement resource.

24. The method of claim 16, further comprising:
receiving, from the UE, a multi-stage CLI capability indicator indicating that the UE is capable of a multi-stage CLI measurement including an RSSI measurement and an RSRP measurement,
wherein the resource configuration indicating the plurality of CLI measurement resources is transmitted in response to the multi-stage CLI capability indicator.

25. The method of claim 16, further comprising:
receiving, from the UE, an RSSI measurement report including the one or more RSSI values exceeding the RSSI threshold and one or more resource indexes respectively indicating the one or more CLI measurement resources.

26. The method of claim 25, further comprising:
transmitting, to the UE in response to the RSSI measurement report, an RSRP measurement request requesting to perform an RSRP measurement on the at least one CLI measurement resource of the one or more CLI measurement resources, a number of the at least one CLI measurement resource being less than or equal to a number of the one or more CLI measurement resources,
wherein the at least one RSRP value is measured on the at least one CLI measurement resource based on the RSRP measurement request.

27. The method of claim 16, further comprising:
transmitting, to the UE, the RSSI threshold.

28. The method of claim 16, wherein the plurality of CLI measurement resources are associated with one or more scrambling codes that are respectively associated with one or more second UEs.

29. The method of claim 28, further comprising:
transmitting, to the UE, association information indicating the association of the plurality of CLI measurement resources with the one or more scrambling codes,
wherein at least one second UE of the one or more second UEs that is associated with the at least one CLI measurement resource is an aggressor UE based on the at least one RSRP value.

30. An apparatus for identifying at least one aggressor UE causing a cross link interference (CLI), comprising:
at least one processor;
a transceiver communicatively coupled to the at least one processor; and
a memory communicatively coupled to the at least one processor,
wherein the at least one processor is configured to:
transmit, to a UE, a resource configuration indicating a plurality of CLI measurement resources;
receive, from the UE, a reference signal received power (RSRP) measurement report, the RSRP measurement report including at least one RSRP value respectively associated with at least one CLI measurement resource of the plurality of CLI measurement resources and further including at least one resource index respectively indicating the at least one CLI measurement resource, wherein the at least one RSRP value is measured on the at least one CLI measurement resource of one or more CLI measurement resources of the plurality of CLI measurement resources, and wherein the one or more CLI measurement resources are associated with one or more receive strength signal indicator (RSSI) values measured on the one or more CLI measurement resources and exceeding the RSSI threshold; and
determine that at least one second UE of one or more second UEs that is associated with the at least one CLI measurement resource is an aggressor UE based on the RSRP measurement report.
